(19) United States
(12) Patent Application Publication
(10) Pub. No.: US 2025/0182400 A1
(43) Pub. Date: Jun. 5, 2025

(54) APPARATUS, METHOD AND READABLE STORAGE MEDIUM FOR WATERMARKING OF 3D OBJECTS

(71) Applicant: Huawei Cloud Computing Technologies Co., Ltd., Gui'an New District (CN)

(72) Inventors: Gursimran Singh, Delta (CA); Mohammad Akbari, Coquitlam (CA); Tianxi Hu, Vancouver (CA); Yong Zhang, Richmond (CA)

(21) Appl. No.: 18/741,139

(22) Filed: Jun. 12, 2024

Related U.S. Application Data
(60) Provisional application No. 63/605,161, filed on Dec. 1, 2023.

(51) Int. Cl. G06T 17/20; G06T 1/00; G06T 7/40; G06V 10/25

(52) U.S. Cl. CPC G06T 17/20; G06T 1/0021; G06T 7/40; G06V 10/25; G06T 2207/30201

(57) ABSTRACT

This disclosure relates to the field of data processing, and discloses an apparatus, method and readable storage medium for watermarking of 3D objects. In this method, the apparatus obtains 3D works (e.g. a 3D model) and watermark parameters of target watermarks to be embedded. And then, the apparatus can determine at least one target box on the 3D model meeting watermark filtering conditions based on the watermark parameters of the target watermarks. The conditions include at least one of roughness, flow degree, overlapping situation and distance of target boxes. After that, the apparatus can embed the target watermarks to the at least one target box on the 3D model. By doing so, the target watermarks can be embedded automatically, and the quality of the target watermarks can be improved due to the introduction of filtering conditions.

### CROSS-REFERENCE TO RELATED APPLICATIONS

This disclosure claims priority to U.S. provisional patent application Ser. No. 63/605,161 filed on Dec. 1, 2023, entitled “Methods and Systems for Automatic Visible Watermarking of 3D Data”, which is incorporated herein by reference in its entirety.

### TECHNICAL FIELD

The present disclosure relates to the field of data processing, and in particular, to an apparatus, method and readable storage medium for watermarking of 3D objects.

### BACKGROUND

With the development of digital visual creation, in education, entertainment, virtual reality, augmented reality and many other fields, all kinds of digital works are in increasing demand. Digital works can include 3D works such as 3D paintings, 3D models and so on. Because the process of creating 3D works is laborious, time-consuming, and requires the creative personnel to master the skillful creation technology, the whole creating process is expensive. Therefore, if 3D works are easy to be copied and pirated illegally by infringers, it will bring huge losses to creators. For example, in the market for 3D works, potential customers will be able to browse or download 3D works via the corresponding website or application. However, some malicious infringers may pose as customers, download and use 3D works by visiting websites or applications without paying any fees to the merchant.

To protect 3D works from infringement, watermarks can be embedded (or added) to 3D works artificially. However, the process of embedding watermarks to 3D works manually requires manual decision-making regarding the number and location of watermark placement, which will bring high cost in the case of a large number of 3D works.

### SUMMARY

The following examples pertain to embodiments described throughout this application.

In a first aspect, there is provided an apparatus, comprising: a memory for storing instructions; one or more processors for executing the instructions to cause the apparatus to: obtain watermark parameters of a target watermark, wherein the watermark parameters include size, thickness, and content of the target watermark; determine multiple target vertices on the surface of a target 3-dimensional (3D) object, wherein the distance between two vertices in the multiple target vertices is greater than a first distance threshold; determine candidate boxes on the target 3D object based on the multiple target vertices and the watermark parameters; determine one or more target boxes meeting a first condition in the candidate boxes based on the watermark parameters of the target watermark, wherein the first condition includes: the roughness corresponding to the one or more target boxes is lower than a roughness threshold, and each of the one or more target boxes indicates a location of the target watermark; and embed the target watermark to the one or more target boxes on the target 3D object to obtain a watermarked target 3D object.

In this method, the target 3D object can also be referred to as a 3D image or a 3D model. Candidate boxes meeting the first condition may be selected as target boxes. And then the target watermark may be embedded to the target boxes to obtain the watermarked target 3D object. The target watermark can be embedded automatically. And the quality of the target boxes can be ensured. Therefore, the quality of the target watermarks can be ensured too.

In one or more possible implementations of the first aspect, determine candidate boxes on the target 3D object based on the multiple target vertices and the watermark parameters comprises: generating bounding boxes at origin based on the watermark parameters of the target watermark; and determining candidate boxes by translating and rotating the bounding boxes, wherein normal direction of each of the candidate boxes is the same as normal direction of corresponding target vertex in the multiple target vertices, and centroids of the candidate boxes coincide with the multiple target vertices.

In this way, the target watermarks are well-aligned with the surface of the model, realizing better security, readability, and visual quality of the target watermark.

In one or more possible implementations of the first aspect, determining candidate boxes by translating and rotating the bounding boxes comprises: obtaining a first model, wherein the first model is obtained by training with a training objective as minimizing distance between the surface of a target object and a middle face in a bounding box, wherein the middle face intersects the bounding boxes into two equal parts in height; and determining candidate boxes by translating and rotating the bounding boxes using the first model.

In this method, the first model can be used to generate candidate boxes based on the bounding boxes directly. For example, after the bounding boxes are generated, the first model can be used to generate candidate boxes by translating and rotating the bounding boxes. In addition, the first model can also be used to fine-tune the candidate boxes. For example, after the bounding boxes are generated, bounding boxes can be translated to the target vertex, and then be rotated to make the normal direction of the bounding boxes and the target vertex is the same, to obtain original candidate boxes. After that, original candidate boxes can be further adjusted by the first model to improve the quality of the candidate boxes.

In one or more possible implementations of the first aspect, determine one or more target boxes meeting a first condition in the candidate boxes based on the watermark parameters of the target watermark comprises: determining roughness corresponding to each of the candidate boxes; and taking candidate boxes with the roughness being lower than the roughness threshold as the one or more target boxes.

A lower roughness score indicates that the surface of the 3D model under the candidate box is relatively flat and is preferred to boost the visibility of the watermarks. Thereafter, the candidate boxes that are placed at flatter areas with low roughness score may be selected and candidate boxes that are placed at rough areas with high roughness score may be removed using a roughness threshold as a parameter. By doing so, the candidate boxes corresponding to better surface of the 3D model can be selected, improving the quality and visibility of the embedded watermarks.

In one or more possible implementations of the first aspect, determining roughness corresponding to each of the candidate boxes comprises: determining similarity between normal vectors of vertices within a first target box of the target boxes on the surface of the target object; and taking an inverse of the similarity as the roughness corresponding to the first target box.

In one or more possible implementations of the first aspect, the first condition further comprises: a flow degree of the one or more target boxes is larger than a flow threshold; and determine one or more target boxes meeting a first condition in the candidate boxes based on the watermark parameters of the target watermark further comprises: determining a flow degree of each of the candidate boxes; and taking candidate boxes with the flow degree being larger than the flow threshold as the one or more target boxes.

When the flow degree (or flow score) is larger than the flow threshold, it can be determined that watermark flows well along the surface of the 3D model. Therefore, the candidate boxes with the flow degree being larger than the flow threshold can be selected. By doing so, the selected candidate boxes' (target boxes') quality can be ensured.

In one or more possible implementations of the first aspect, determining a flow degree of each of the candidate boxes comprises: determining first faces inside the first target box, wherein each of the first faces has three vertices inside the first target box; projecting the first faces along a normal vector of the first target box, to obtain first projected areas corresponding to the first faces; and taking the summation of the first projected areas as the flow degree of the first target box.

In this implementation, only faces totally inside the first target box is used to determine the flow degree of the target boxes, which can ensure the accuracy of the calculated flow degree.

In one or more possible implementations of the first aspect, determining a flow degree of each of the candidate boxes comprises: determining first faces inside the first target box and second faces partially inside the first target box, wherein each of the first faces has three vertices inside the first target box, and each of the second faces has one or two vertices inside the first target box; projecting the first faces and the second faces along normal vectors of the first target box, to obtain first projected areas and second projected areas respectively; and taking the summation of the first projected areas and the second projected areas as the flow degree of the first target box.

In this implementation, instead of only taking faces totally inside the first target box into consideration, faces partially inside the first target box are also taken into consideration, which further improve the accuracy of the calculated flow degree.

In one or more possible implementations of the first aspect, the first condition further comprises at least one of: there being no overlapping boxes between the one or more target boxes, or a distance between the one or more target boxes meets a distance condition.

In this way, the candidate boxes overlapping with each other will not be selected as target boxes, and/or the candidate boxes who are too close with each other will not be selected as target boxes. After the watermarks are embedded to the model, this method can ensure that the watermarks on the model have good quality, because there are no overlapping watermarks, or watermarks that are too close.

In one or more possible implementations of the first aspect, the distance condition includes: the distance is larger than a second distance threshold, or the distance is in the top K number of all distances between the candidate boxes.

In one or more possible implementations of the first aspect, the distance between the one or more target boxes is determined based on a distance between centroids of the one or more target boxes.

In one or more possible implementations of the first aspect, embed the target watermark to the one or more target boxes on the target 3D object to obtain a watermarked target 3D object comprises: generating target watermark meshes at locations of the one or more target boxes based on the watermark parameters; and obtaining the watermarked target 3D object based on the target watermark meshes and 3D mesh of the target 3D object.

In one or more possible implementations of the first aspect, obtaining the watermarked target 3D object based on the target watermark meshes and 3D mesh of the target 3D object comprises: determining an intersection face of the 3D mesh and each of the target watermark meshes; moving each vertex in the intersection face for a first distance along normal vectors of corresponding target watermark mesh to obtain a new target watermark mesh; and generating the watermarked target 3D object based on the 3D mesh and the new target watermark mesh.

It can be understood that after embedding the watermarks into the model, the watermarks may not follow the local curvature of the surface of the model, because the curvature of the surface is not considered. That is to say, a flat textual surface of the watermarks will be created on the curved surface of the model, which affects the visual quality (utility) of the watermarked 3D model. Therefore, in the method above, the watermarks can follow the local curvature, increasing the quality of the watermark.

In one or more possible implementations of the first aspect, generating the watermarked target 3D object based on the 3D mesh and the new target watermark mesh comprises: generating the watermarked target 3D object by taking a Boolean union method of the 3D mesh and the new target watermark mesh.

In one or more possible implementations of the first aspect, the first condition further comprises at least one of: at least one target box lies within each target part of the target object; the at least one target box is visible at a first view; or the at least one target box lies within each face with a span of a first viewing angle on the target object's surface.

The condition mentioned above can further restrict the selected candidate boxes (target boxes). By doing so, the quality of the target boxes, and even the target watermark can be further improved.

In a second aspect, there is provided a method, comprising: obtaining watermark parameters of a target watermark, wherein the watermark parameters include size, thickness and content of the target watermark; determining multiple target vertices on the surface of a target 3-dimensional (3D) object, wherein the distance between two vertices in the multiple target vertices is greater than a first distance threshold; determining candidate boxes on the target 3D object based on the multiple target vertices and the watermark parameters; determining one or more target boxes meeting a first condition in the candidate boxes based on the watermark parameters of the target watermark, wherein the first condition includes: the roughness corresponding to the one or more target boxes is lower than a roughness threshold, and each of the one or more target boxes indicates a location of the target watermark; and embedding the target watermark to the one or more target boxes on the target 3D object to obtain a watermarked target 3D object, with the target watermark embedded into the target 3D object.

In one or more possible implementations of the second aspect, determining candidate boxes on the target 3D object based on the multiple target vertices and the watermark parameters comprises: generating bounding boxes at origin based on the watermark parameters of the target watermark; and determining candidate boxes by translating and rotating the bounding boxes, wherein normal direction of each of the candidate boxes is the same as normal direction of corresponding target vertex in the multiple target vertices, and centroids of the candidate boxes coincide with the multiple target vertices.

In one or more possible implementations of the second aspect, determining candidate boxes by translating and rotating the bounding boxes comprises: obtaining a first model, wherein the first model is obtained by training with a training objective as minimizing distance between the surface of a target object and a middle face in a bounding box, wherein the middle face intersects the bounding boxes into two equal parts in height; and determining candidate boxes by translating and rotating the bounding boxes using the first model.

In one or more possible implementations of the second aspect, determining one or more target boxes meeting a first condition in the candidate boxes based on the watermark parameters of the target watermark comprises: determining roughness corresponding to each of the candidate boxes; and taking candidate boxes with the roughness being lower than the roughness threshold as the one or more target boxes.

In one or more possible implementations of the second aspect, determining roughness corresponding to each of the candidate boxes comprises: determining similarity between normal vectors of vertices within a first target box of the target boxes on the surface of the target object; and taking an inverse of the similarity as the roughness corresponding to the first target box.

In one or more possible implementations of the second aspect, the first condition further comprises: a flow degree of the one or more target boxes is larger than a flow threshold; and determining one or more target boxes meeting a first condition in the candidate boxes based on the watermark parameters of the target watermark further comprises: determining a flow degree of each of the candidate boxes; and taking candidate boxes with the flow degree being larger than the flow threshold as the one or more target boxes.

In one or more possible implementations of the second aspect, determining a flow degree of each of the candidate boxes comprises: determining first faces inside the first target box, wherein each of the first faces has three vertices inside the first target box; projecting the first faces along a normal vector of the first target box, to obtain first projected areas corresponding to the first faces; and taking the summation of the first projected areas as the flow degree of the first target box.

In one or more possible implementations of the second aspect, determining a flow degree of each of the candidate boxes comprises: determining first faces inside the first target box and second faces partially inside the first target box, wherein each of the first faces has three vertices inside the first target box, and each of the second faces has one or two vertices inside the first target box; projecting the first faces and the second faces along normal vectors of the first target box, to obtain first projected areas and second projected areas respectively; and taking the summation of the first projected areas and the second projected areas as the flow degree of the first target box.

In one or more possible implementations of the second aspect, the first condition further comprises at least one of: there being no overlapping boxes between the one or more target boxes, or a distance between the one or more target boxes meets a distance condition.

In one or more possible implementations of the second aspect, the distance condition includes: the distance is larger than a second distance threshold, or the distance is in the top K number of all distances between the candidate boxes.

In one or more possible implementations of the second aspect, the distance between the one or more target boxes is determined based on a distance between centroids of the one or more target boxes.

In one or more possible implementations of the second aspect, embedding the target watermark to the one or more target boxes on the target 3D object to obtain a watermarked target 3D object comprises: generating target watermark meshes at locations of the one or more target boxes based on the watermark parameters; and obtaining the watermarked target 3D object based on the target watermark meshes and 3D mesh of the target 3D object.

In one or more possible implementations of the second aspect, obtaining the watermarked target 3D object based on the target watermark meshes and 3D mesh of the target 3D object comprises: determining an intersection face of the 3D mesh and each of the target watermark meshes; moving each vertex in the intersection face for a first distance along normal vectors of corresponding target watermark mesh to obtain a new target watermark mesh; and generating the watermarked target 3D object based on the 3D mesh and the new target watermark mesh.

In one or more possible implementations of the second aspect, generating the watermarked target 3D object based on the 3D mesh and the new target watermark mesh comprises: generating the watermarked target 3D object by taking a Boolean union method of the 3D mesh and the new target watermark mesh.

In one or more possible implementations of the second aspect, the first condition further comprises at least one of: at least one target box lies within each target part of the target object; the at least one target box is visible at a first view; or the at least one target box lies within each face with a span of a first viewing angle on the target object's surface.

In a third aspect, there is provided a non-transitory machine-readable storage medium storing instructions, wherein when the instructions are executed by one or more processors of a machine, cause the machine to: obtain watermark parameters of a target watermark, wherein the watermark parameters include size, thickness, and content of the target watermark; determine multiple target vertices on the surface of a target 3-dimensional (3D) object, wherein the distance between two vertices in the multiple target vertices is greater than a first distance threshold; determine candidate boxes on the target 3D object based on the multiple target vertices and the watermark parameters; determine one or more target boxes meeting a first condition in the candidate boxes based on the watermark parameters of the target watermark, wherein the first condition includes: the roughness corresponding to the one or more target boxes is lower than a roughness threshold, and each of the one or more target boxes indicates a location of the target watermark; and embed the target watermark to the one or more target boxes on the target 3D object to obtain a watermarked target 3D object.

In a fourth aspect, there is provided a computer program product comprising instructions, wherein when the instructions are executed by one or more processors of a machine, the instructions cause the machine to execute the method mentioned in the second aspect.

The beneficial effects of the second aspect to the fourth aspect can be referred to those of the first aspect, which will not be described in detail herein again.

### BRIEF DESCRIPTION OF THE DRAWINGS

FIG. 1 shows a schematic scenario diagram of embedding a watermark based on a 2D texture using 3D graphics and image software, according to some embodiments of this disclosure.

FIG. 2 shows a schematic flow diagram of a data processing method, according to some embodiments of this disclosure.

FIG. 3 shows a schematic scenario diagram of a data processing system 300 applying the data processing method, according to some embodiments of this disclosure.

FIG. 4 shows a schematic scenario diagram of input and output of the data processing system 300, according to some embodiments of this disclosure.

FIG. 5 shows a schematic structural diagram of the modules of the data processing system 300, according to some embodiments of this disclosure.

FIG. 6 shows a schematic structural diagram of the sub-modules of CBGSRM 501, according to some embodiments of this disclosure.

FIG. 7A shows a schematic diagram of random vertices, target vertices and candidate boxes, according to some embodiments of this disclosure.

FIG. 7B shows a schematic diagram of algorithm for candidate-box generation, according to some embodiments of this disclosure.

FIG. 7C shows a schematic diagram of algorithm for candidate box space registration, according to some embodiments of this disclosure.

FIG. 7D shows a schematic diagram of a new CBGSRM 501 including candidate box fine-tuning sub-module, according to some embodiments of this disclosure.

FIG. 7E shows a schematic diagram of candidate boxes after fine-tuning, according to some embodiments of this disclosure.

FIG. 8A shows a schematic structural diagram of the sub-modules of CBFM 502, according to some embodiments of this disclosure.

FIG. 8B shows a schematic diagram of candidate boxes going through filtering, according to some embodiments of this disclosure.

FIG. 8C shows a schematic structural diagram of high flow sub-module 5021, according to some embodiments of this disclosure.

FIG. 8D shows a schematic diagram of algorithm for high flow filter, according to some embodiments of this disclosure.

FIG. 9A shows a schematic structural diagram of low roughness sub-module 5022, according to some embodiments of this disclosure.

FIG. 9B shows a schematic diagram of algorithm for low roughness filter, according to some embodiments of this disclosure.

FIG. 9C shows a schematic diagram of algorithm for non-overlap filter, according to some embodiments of this disclosure.

FIG. 9D shows a schematic diagram of algorithm for max distance filter, according to some embodiments of this disclosure.

FIG. 9E shows a schematic diagram of algorithm for vertex inside test, according to some embodiments of this disclosure.

FIG. 9F shows a schematic diagram of algorithm for face inside test, according to some embodiments of this disclosure.

FIG. 9G shows a schematic diagram of algorithm for improved candidate boxes generation, according to some embodiments of this disclosure.

FIG. 9H shows a schematic diagram of algorithm for improved candidate boxes generation, according to some embodiments of this disclosure.

FIG. 9I shows a schematic diagram of algorithm for face intersect test, according to some embodiments of this disclosure.

FIG. 10 shows another schematic structural diagram of the sub-modules of CBFM 502, according to some embodiments of this disclosure.

FIG. 11A shows a schematic structural diagram of the sub-modules of WGFM 503, according to some embodiments of this disclosure.

FIG. 11B shows a schematic diagram of comparison between 3D model with filtered candidate boxes and with watermarks placed at (target) box locations, according to some embodiments of this disclosure.

FIG. 11C shows a schematic diagram of algorithm for curve matching fusion, according to some embodiments of this disclosure.

FIG. 12 shows another schematic flow diagram of a data processing method, according to some embodiments of this disclosure.

FIG. 13 shows a schematic structural diagram of an apparatus 1400, according to some embodiments of this disclosure.

### DETAILED DESCRIPTION

Illustrative embodiments of the present disclosure include, but are not limited to, an apparatus, method and readable storage medium for watermarking of 3D objects.

The method in this disclosure is applicable to all types of apparatus capable of acquiring/processing data, which may include mobile terminals such as mobile phones, tablet computers, wearable devices, etc. In addition, the apparatus can also include personal computers (PC), laptops, netbooks, ultra-mobile personal computers (UMPC), hardware servers (including: entry-level servers, workgroup servers, departmental servers, and enterprise servers), cloud servers, and so on.

Before introducing the data processing method involved in this disclosure, some terms involved are explained.

Data processing: in this disclosure, the data processing can mean embedding watermarks to a digital work. A watermark represents a mark that can be embedded (or added) into a digital work. The watermarks can be used to prove the ownership of a work or to indicate the source information of a digital work.

Piracy: the act of illegally making, using and distributing copies of works/products protected by intellectual property rights.

3D works: also known as 3D models in this disclosure, can be represented in 3D mesh. For example, a model is described using vertices (3D points), edges (lines connecting two vertices), and faces (three or more vertices connected into a face, including a triangular face or a quadrangular face, etc.).

After introducing the terms involved in the embodiment of the disclosure, the following is a description of the several technical solutions of the application in relation to specific scenarios.

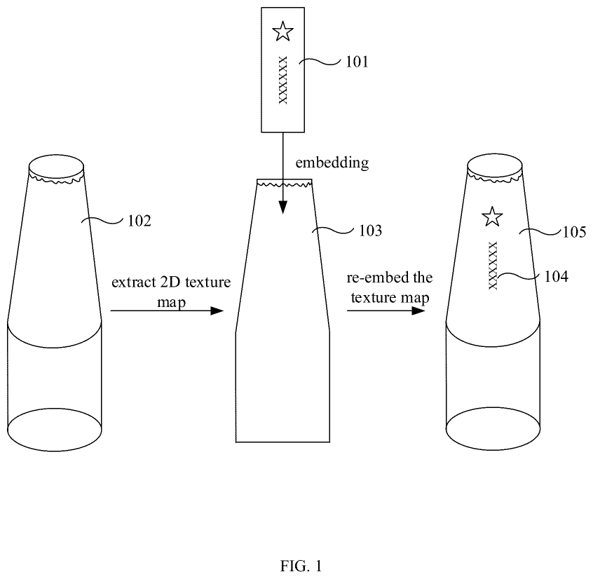

FIG. 1 shows a schematic scenario diagram of embedding a watermark based on a 2D texture using 3D graphics and image software, e.g. Blender™. The watermark is embedded to 2D-based texture maps of 3D works (or 3D data) through 3D graphics and image software (or 3D processing software). In FIG. 1, the watermark 101 can be a 2D texture watermark, and embedding the watermark 101 to the 3D work 102 can include the following steps.
Step 1: extract 2D texture map of the 3D work 102 using 3D processing software. By doing so, the 2D texture map 103 can be obtained.
Step 2: embed the watermark 101 to the selected locations in the texture map 103, where the watermark 101 can be a 2D visible watermark.
Step 3: re-embed the texture map 103 with the watermark 101 on the 3D work 102 using the 3D processing software, to obtain a 3D work 105 including a 3D watermark 104.

It can be learnt that for the 2D texture-based watermark applying method shown in FIG. 1, the process is conducted by human effort. Therefore, embedding the watermark will cost a lot of time and effort. In addition, the watermark may be easily removed by removing the texture information from the 3D work, reducing the security of the 3D work with watermark.

In some other examples, 3D watermark can also be embedded using 3D graphics and image software, e.g. Meshmixer™ Still taking FIG. 1 as an example, if the 3D watermark 104 is embedded to the 3D work 105, the 3D watermark 104 may be converted to 3D watermark mesh using software manually. Then, the locations of placing the 3D watermark mesh may be manually identified, and this step will be repeated for each watermark. After that, the locations or areas may be prepared to allow embossing manually, e.g., remeshing the locations or areas. Then, the 3D watermark mesh may be moved and oriented at the locations manually. Finally, mesh mixing operation (Boolean union/difference, etc.) may be used to emboss the watermark on the surface of 3D work 105. By doing so, the 3D watermark 104 is embedded (or added) into the 3D work 105.

In this method, deciding where to place 3D watermarks may involve human effort, making it laborious, time-consuming and costly. In addition, the process needs to be repeated for each watermark, making the method unscalable.

According to two methods mentioned above, it can be seen that these two methods may be conducted manually, making the watermark embedding process time-consuming, and reducing the efficiency of generating a 3D work with watermarks.

So based on this, there is an automatic watermarking method using mesh subdivision. In this method, mesh subdivision is adopted to embed the watermark automatically. The steps of this method are as follows. Firstly, a smooth area of the 3D work using the sum of angles between normal vectors of k-hop neighborhood may be identified. Secondly, the identified smooth area can be projected on a 2D plane surface. Thirdly, the watermark is superimposed on the project area and a combination of cropping and subdivision is used to embed the visible watermark. Lastly, the area can be projected back to the original 3D work.

In this method, the watermark embedded by subdivision has poor visibility. They are designed to be only viewed using mesh-editing software that can display edge information. Hence, they are not visible to the naked eye in rendering mode or after printing the 3D model. What's more, the overall quality of the 3D work with watermark isn't considered. For example, the watermark may be flying out of the 3D work. Therefore, the quality of the 3D work with watermark is relatively low. In addition, the watermark can be easily removed by algorithms which can randomly subdivide the mesh with a constraint of not effecting the geometry. So the security of the 3D work with watermark is also relatively low.

Therefore, in order to solve above problems, the embodiment of this application proposes a data processing method, which can realize the automatic embedding of the watermark (also known as the visible watermark) into 3D works. The data processing method includes: the apparatus obtains 3D works (hereinafter referred to as 3D (mesh) model), and watermark parameters (for example, watermark's size, watermark's thickness, watermark's font, watermark's text, etc.) of watermarks to be embedded (hereinafter referred to as the target watermarks). And then, the apparatus can determine at least one target box on the 3D model meeting watermark filtering conditions (an example of the first condition) based on the watermark parameters of the target watermarks. After that, the apparatus can embed the target watermarks to the at least one target box on the 3D model.

In some embodiments, the watermark's size may include the length, width of the watermarks. Specifically, after the apparatus obtains the parameters of the target watermarks and the 3D model, the apparatus can first determine the bounding boxes of the target watermarks according to the parameters and multiple target vertices on the 3D model. Then the apparatus can transport the bounding boxes at the target vertices, to obtain candidate boxes. In detail, the distance between the target vertices is larger than a first distance threshold.

What's more, after the bounding boxes are transported at the target vertices, normal vectors of the bounding boxes may be adjusted. That is to say, the normal vector of each candidate box is aligned with that of the target vertex corresponding to the candidate box. For example, the normal vector of each candidate box and that of the target vertex corresponding to the candidate box are parallel.

In some embodiments, after determining the candidate boxes, the apparatus can also remove the candidate boxes that do not meet the first condition, and take the rest candidate boxes as target boxes. For example, the apparatus can remove the candidate boxes whose roughness, flow degree, distance, or overlapping situation do not meet a corresponding condition threshold.

In addition, the first condition includes at least one of the following: the roughness corresponding to the target box is lower than a roughness threshold; the flow degree of the target box is larger than a flow threshold; there is no overlapping box among the at least one target box; and the distance of the at least one target box is larger than or equal to a distance threshold (as an example of the second distance threshold).

Specifically, the roughness corresponding to the target box refers to the roughness of an area on the surface of the 3D model corresponding to the target box.

The specific content of the first condition is not limited in this application. For example, the first condition can include at least one of the above types. For the first condition including more than one type, the determining order of the more than one type is also not limited in this application.

In other embodiments, if there are multiple target boxes, the apparatus can embed watermarks to all of the multiple target boxes, or, the apparatus can also automatically select one or more target boxes from multiple target boxes to embed watermarks, or the apparatus can embed watermarks to one or more target boxes selected by the user from the multiple target boxes.

In some embodiments, each area or spatial region on the surface of the 3D model may have at least one target boxes. That is to say, each spatial region may have at least one target watermark.

According to above description, the benefits of this method are as follows.

Firstly, the method avoids embedding too many target watermarks to a 3D model to mask most of the significant details of the 3D model, improving the asset utility of the 3D model.

Secondly, through the above method, multiple target watermarks can be embedded to the 3D model, and avoid that embedding too few target watermarks may affect the security of the 3D model, because infringers may illegally use a 3D model that does not contain any watermark to render the 3D model into a 2D image. Therefore, security and usability of the 3D model in this application can also be improved.

Thirdly, the target watermarks are well-aligned with the surface of the 3D model, realizing better security, readability, and visual quality. For instance, a non-aligned target watermark has some letters of the watermark either sticking out or going inside the surface of the 3D model. These floating letters can be easily identified and removed by an automated algorithm as isolated parts, thereby compromising the security of the target watermark. In addition, if part of a target watermark is going inside the surface of a 3D model, it may be hard to read the complete watermark message, compromising the readability of the target watermarks. What's more, target watermarks that do not follow the surface of the 3D model have lower visual quality to users. Therefore, the method in this application can avoid the above several situations, so the target watermarks in this application boast higher quality.

Fourthly, in the method, the 3D model can be divided into several spatial regions, and each spatial region may have at least one target watermark. In addition, the target watermarks can also be visible and readable for users from multiple (camera) angles around the 3D model, improving the visibility of the target watermarks and reducing the possibility of the 3D model being used by others illegally.

It can be understood that the above method can not only improve the quality of target watermarks, but also improve the asset utility. For example, when larger number of target watermarks are embedded to a 3D model, or when the location of embedded target watermarks coincides with highly salient areas, the asset utility is better.

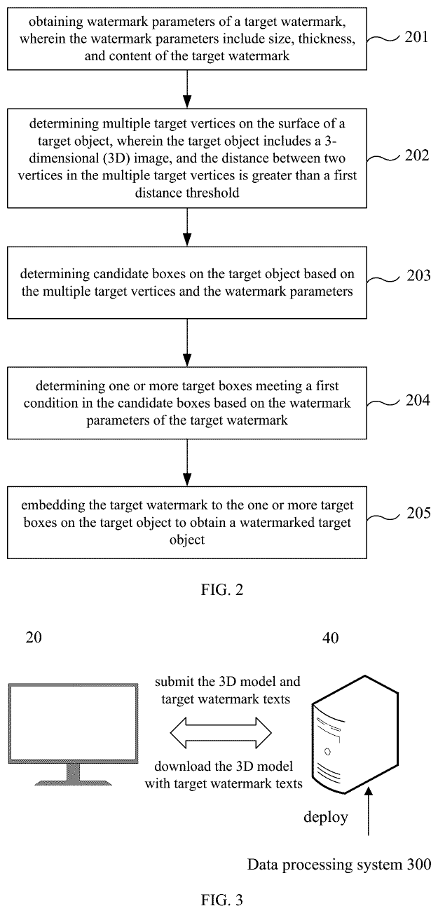

FIG. 2 shows a schematic flow diagram of a data processing method in this disclosure. As shown in FIG. 2, the method can include the following steps.

S201: obtaining watermark parameters of a target watermark, wherein the watermark parameters include size, thickness, and content of the target watermark.

Illustratively, the size of the target watermark can include the length and width, and the thickness can be the height of the target watermark. In some embodiments, the content of the target watermark is not limited. For example, the content may be a text, a shape, a symbol, etc.

S202: determining multiple target vertices on the surface of a target 3-dimensional (3D) object, wherein the distance between two vertices in the multiple target vertices is greater than a first distance threshold.

Illustratively, the target 3D object can be referred to as a 3D image or a 3D model in this disclosure. In this step, the distance between two vertices is greater than a first distance threshold, which aims to ensure that two vertices will not be too close to each other, avoiding that the candidate boxes or even target watermarks on the vertices overlap with each other.

S203: determining candidate boxes on the target 3D object based on the multiple target vertices and the watermark parameters.

In some embodiments, normal direction of each of the candidate boxes is the same as that of corresponding target vertex in the multiple target vertices.

Illustratively, centroids of the candidate boxes coincide with the target vertices.

S204: determining one or more target boxes meeting a first condition in the candidate boxes based on the watermark parameters of the target watermark.

In some embodiments, the first condition includes: the roughness corresponding to the one or more target boxes is lower than a roughness threshold, and each of the one or more target boxes indicates a location of the target watermark.

Illustratively, the roughness can be determined based on similarity between normal vectors of vertices within target boxes on the surface of the target object. And in addition, the roughness can be an inverse of the similarity. For example, for a target box (as an example of the first target box), similarity between normal vectors of vertices within the first target box can be determined, and the inverse of the similarity can be taken as the roughness corresponding to the first target box.

In addition to the roughness, the first condition may also include conditions on flow degree, overlap, and so on, which will be described in detail in the following content.

S205: embedding the target watermark to the one or more target boxes on the target 3D object to obtain a watermarked target 3D object.

Based on above description, in the data processing method provided in the embodiment of this application, the target boxes meeting the first condition can be selected automatically. And then the target watermarks are embedded to the target boxes, so that the target watermarks are embedded to the 3D model. So, the method automatically determines the number, orientation, and location of target watermarks to achieve better watermark quality and better asset quality.

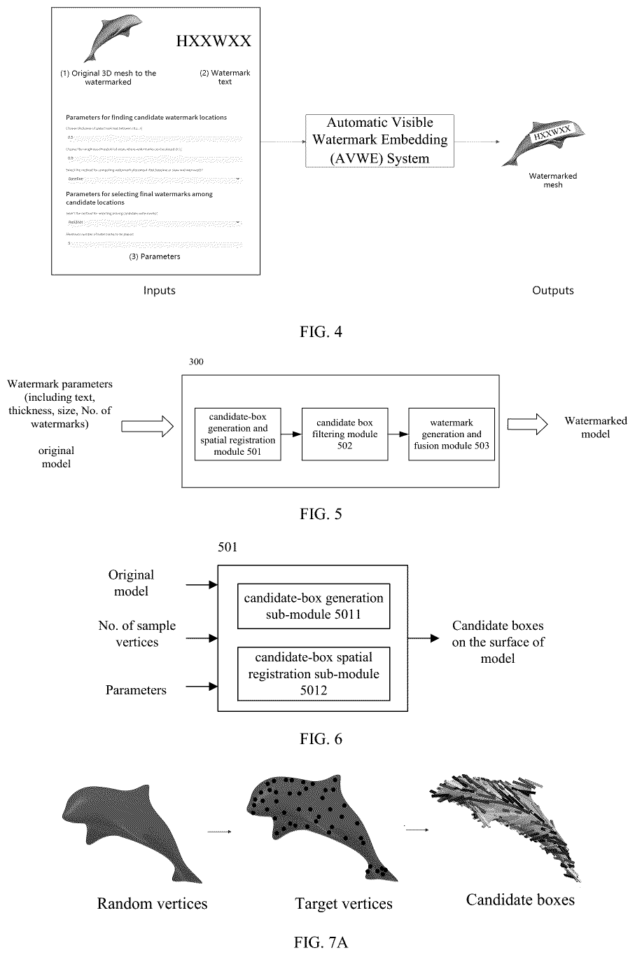

FIG. 3 shows a schematic scenario diagram of a data processing system 300 applying the data processing method. As shown in FIG. 3, the data processing system 300 can be deployed on a server 40. As shown in FIG. 4, the data processing system 300 can also be referred to as an automatic visible watermark embedding (AVWE) system. The input of the data processing system 300 can include: original 3D mesh to be watermarked (e.g. 3D model), target watermark content (e.g. texts) and other watermark parameters, wherein the watermark texts can be text string, e.g. HXXWXX. For example, other parameters can include parameters for finding candidate watermark locations (e.g. candidate boxes). The output can include a 3D model (e.g. watermarked mesh) with target watermark texts which are embedded in the geometry of the 3D model (such as vertices and faces). Users can access the interface provided by the data processing system 300 through client 20 (e.g. mobile phone, personal computer, etc.), to submit the 3D model and target watermark texts through the interface. What's more, the user can also download the 3D model with target watermark texts through the interface.

For ease of description, the following will take text as an example of the content of the watermark to describe the method in this disclosure.

In some embodiments, users can also submit a 3D model and target watermark texts to server 40 running the data processing system 300 through the command line of the operating system of the client 20, and then the 3D model with target watermark texts may be written directly to the file system of client 20 used by users.

It can be understood that the above two different situations are just illustrative examples of the methods for users to obtain the generated 3D model with target watermark texts. The methods to obtain the generated 3D model with target watermark texts are not limited in this disclosure.

In other embodiments, as shown in FIG. 4, the data processing system 300 can also be referred to as an automatic visible watermark embedding (AVWE) system. The data processing system 300 can be deployed on a single computer or server, and it can also be distributed across multiple standalone computers or servers, or hosted in the cloud. That is to say, automatically visible 3D watermark embedding online services, can be distributed in multiple separate computers or servers or hosted in the cloud. Users can input the 3D model and the target watermark texts through a service interface provided by the cloud, and download the 3D model with target watermark texts.

In addition to the 3D model and the text of watermarks, the input of the data processing system 300 may also include other watermark parameters. Specifically, the input can also include the watermark's size, watermark's font, watermark's thickness, and the number of target watermarks. The thickness can be the height of the watermarks, and the size of the watermarks can include the length and width of the watermarks. The number of watermarks represents the number of watermarks that need to be embedded to the 3D model. And the number of watermarks can be a preset fixed number, or it can be an intensity factor. That is to say, the number of watermarks can be determined automatically according to the intensity factor by the algorithm provided by the data processing system 300.

In some embodiments, the input of the data processing system 300 may also include watermark filtering conditions or criteria. The watermark filtering conditions can include one or more of the following.

Condition related to the roughness of the surface on the 3D model for placing watermarks. When the roughness corresponding to a watermark is lower than a roughness threshold, the surface can be determined is relatively flat and is suitable for embedding watermarks. Therefore, the watermark can be selected.

Condition related to the flow degree of the watermarks. When the flow degree (or flow score) is larger than a flow threshold, it can be determined that watermark flows along the surface of the 3D model. Therefore, if a watermark's flow degree is larger than a flow threshold, the watermark can be selected.

Condition related to top K watermarks. For example, the top K watermarks can be selected from all the watermarks. The value of K can be a preset value.

Condition related to max distance. When the distance between watermarks is larger than a distance threshold, the watermarks can be selected.

Condition related to viewing angles. For example, there may be at least one watermark in different regions/surfaces of the 3D model. The different regions/surfaces can be set according to real applying scenarios. For example, the different regions/surfaces can be determined by the (camera) angle at which the user views the 3D model, so that the watermarks of the 3D model can be seen from all directions/angles.

In some embodiments, the output of the data processing system 300 is a 3D model with visible watermarks placed on the model's surface.

It can be seen that the data processing system 300 can implement automatic recognition of suitable locations to embed watermarks on the surface of the 3D mesh model based on the input 3D model and various parameters of watermarks, after a series of filtering/processing. Therefore, the quality and visibility of embedded watermarks are relatively high.

FIG. 5 shows a schematic structural diagram of the modules of the data processing system 300. The data processing system 300 can include three core modules: candidate-box generation and spatial registration module (CBGSRM) 501, candidate box filtering module (CBFM) 502, and watermark generation and fusion module (WGFM) 503. The input of the data processing system 300 is watermark parameters and original model (original 3D model or 3D image), and the output is watermarked model (an example of the watermarked target 3D object).

The data processing process between each module can include the following. Firstly, CBGSRM 501 generates a number of candidate boxes that act as placeholders for putting watermarks and transforms to place them at various locations of the surface of a 3D model. Secondly, CBFM 502 filters and selects the target boxes from the candidate boxes output by CBGSRM 501. The aim is to fulfil the high watermark quality and high asset utility requirements. At last, WGFM 503 embosses the actual 3D text watermarks into the 3D model's surface based on the location and orientation of the chosen placeholder boxes. It means that the actual 3D text watermarks can be applied to the 3D model by being applied to target boxes output by the CBFM 502.

It can be seen that through the modules of the data processing system 300 shown in FIG. 5, the number, orientation and position of watermarks that can be embedded in the 3D model can be automatically determined, ensuring that the 3D model after embedding watermarks has better watermark quality and asset quality.

In addition, the data processing system 300 can achieve low cost and scalability. The low cost can mean the labor cost savings for the users to manually embed the watermarks. Through the data processing system 300, the optimal position of embedding (or embedding) watermarks on the 3D model can be automatically identified to obtain better visibility. Watermarks can be embedded in relatively flat locations, rather than random locations, which can improve the visibility of the embedded watermarks. Moreover, the process of embedding watermarks may be achieved by the data processing system 300 without any manual intervention, making the whole process fully automated, which can save a lot of labor and financial costs.

The scalability indicates that the data processing system 300 can be applied to automatically embed visible watermarks to a large number of 3D models. Because of the low cost of using the data processing system 300, it can be widely used in various 3D models.

In some embodiments, watermarks embedded through the data processing system 300 also have high watermark quality. That is to say, the watermarks have high readability and security. And the watermarks embedded in the 3D model can be clearly visible from all angles, and the watermarks are well oriented/fitted along the surface of the 3D model.

The following describes in detail each module and sub-modules of each module as well as process corresponding to each module.

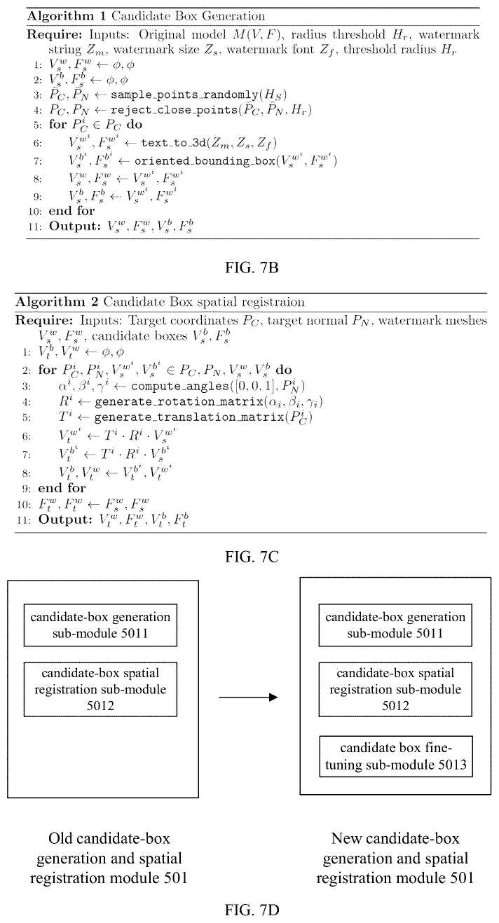

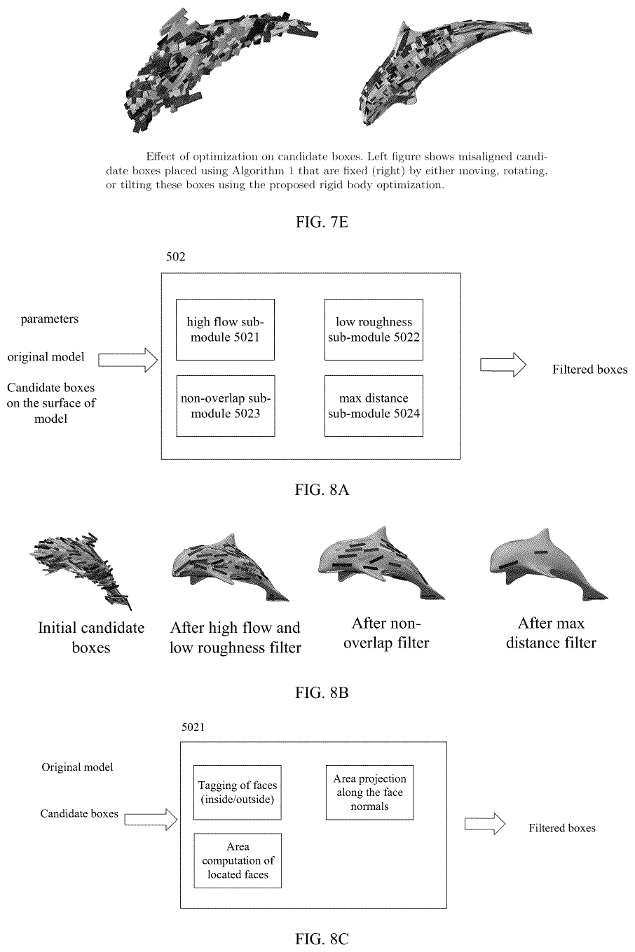

The CBGSRM 501 will be described in detail based on FIG. 6 and FIG. 7A.

As shown in FIG. 6, the CBGSRM 501 can take as input the 3D model (original model), the number of sample points and parameters of watermarks and generates a large number of candidate boxes all across the surface of the 3D model.

In this disclosure, the candidate boxes can be used as potential positions for placing watermarks on the surface of the 3D model. The main advantage of candidate boxes instead of actual watermarks is that boxes and can be used to estimate the goodness of position and orientation of placing watermarks in an easy manner.

As shown in FIG. 7A, the CBGSRM 501 can first identify target points from a set of vertices on the surface of the 3D model. For example, the surface of 3D model includes m vertices, the vertices whose distance is greater than a distance threshold can be taken as target points. The candidate boxes are then generated at the target points.

It can be seen that, removing vertices with relatively short distance first can make the data processing system 300 estimate the position and orientation of the watermarks more quickly and efficiently.

In some embodiments, the 3D model M may be represented as a five-dimensional data format corresponding to M (V, F, T, N, E), where V represents a set of vertices consisting of (x, y, z) points in 3D space. F represents a set of faces made by three or more edges in a closed loop. T represents texture information consisting of an RGB 2D image and a UV map. T can be used as auxiliary information, and T is optional.

N represents normal vectors computed for each vertex and face of the 3D model. E represents a set of all edges connecting two vertices of the 3D model. It can be known that that N and E are both auxiliary information, they are optional as they can be computed based on V, F etc.

Understandably, the data of each dimension of the 3D model M (V, F, T, N, E) may be not all required in the data processing system 300. The data processing system 300 can use all or part of the data in M to embed watermarks to the 3D model.

As shown in FIG. 6, the CBGSRM 501 can include candidate-box generation sub-module 5011 and candidate-box spatial registration sub-module 5012. The description of each sub-module is as follows.

In some embodiments, the candidate-box generation sub-module 5011 can be used to generate a number of bounding boxes at origin that needs to be transported to the surface of the 3D model, and act as placeholders for putting watermarks. The bounding boxes are 3D structures (e.g. cubes) based on the size and thickness of the watermarks, and the bounding boxes can be placed on the surface of the 3D model.

In some embodiments, the candidate-box generation sub-module 5011 can generate candidate boxes corresponding to the 3D model by the method as described in FIG. 7B. As shown in FIG. 7B, the input can further include: 3D model, random vertices H_{S}, watermark parameters, watermark thickness, and threshold radius H_{R}. The random points H_{S} and threshold radius H_{R} can be pre-set or determined based on 3D model, watermark parameters and so on.

The output may include: 3D mesh (Vₛ^{w},Fₛ^{w}) of watermarks added to the origin (0, 0, 0) and its corresponding bounding boxes (Vₛ^{b},Fₛ^{b}). The 3D model can be represented as original model M (V, F)). Watermark parameters can include: watermark text Zₘ, watermark size Zₛ and watermark font Z_{f}.

Continuing with FIG. 7B, the method may include the following steps:

S701b: initializing the 3D mesh (Vₛ^{w}, Fₛ^{w}) of the watermarks and its corresponding bounding boxes (Vₛ^{b}, Fₛ^{b}), according to line 1 and line 2.

S702b: determining on large number of random vertices H_{S} on the surface of 3D model according to line 3. And in line 3, the subscript C refers to actual 3D locations on the surface of the 3D model and N refers to surface normal vectors corresponding to these points on the 3D model's surface.

S703b: removing vertices that are too close (distance less than H_{R}) from random vertices H_{S} and receiving the final number H of vertices, and the vertices can be represented by (P_{C}, P_{N}) (as an example of target vertices) whose distance is larger than H_{R} according to line 4. And P_{c} refers to 3D locations of vertices and P_{N} refers to normal vectors of vertices.

In some embodiments, the target vertices can be taken as output of the candidate-box generation sub-module 5011.

S704b: for each vertex of (P_{C}, P_{N}), generating 3D mesh (Vₛ^{w}^{ᵢ}, Fₛ^{w}^{ᵢ}) corresponding to each vertex using 3D text algorithm (e.g. text_to_3D) based on watermark text Zₘ, watermark size Zₛ and watermark font Z_{f}.

In addition, generating the bounding box (Vₛ^{b}^{ᵢ}, Fₛ^{b}^{ᵢ}) of the 3D mesh (Vₛ^{w}^{ᵢ}, Fₛ^{w}^{ᵢ}) using bounding box generating algorithm (e.g. oriented_bounding_box). Thus, 3D meshes (Vₛ^{w}, Fₛ^{w}) and their bounding boxes (Vₛ^{b}, Fₛ^{b}) corresponding to all target vertices can be obtained. This step corresponds to lines 5 to 9.

In some embodiments, these 3D meshes are generated at origin (0, 0, 0) and the face of the 3D meshes faces towards the +Z direction (0, 0, 1), also referred as top direction.

It can be seen that the bounding boxes can also be determined based on the thickness. Therefore, the bounding boxes can be a 3D structure determined based on length, width and thickness (or height) of the watermarks.

In some embodiments, the bounding boxes act as a placeholders for the watermarks and are used in the following modules for estimate the goodness of locations and orientations of 3D watermarks.

The candidate box space registration sub-module 5012 is used to transport the bounding boxes at specific locations on the surface of the 3D model and orient the bounding boxes towards the surface normal vector using 3D rigid body transformations, to obtain the candidate boxes.

In some embodiments, the candidate box space registration sub-module 5012 can determine candidate boxes corresponding to the 3D model by the method as described in FIG. 7C. As shown in FIG. 7C, the input to this method can further include: the target vertices (P_{C}, P_{N}) determined by the candidate box generation sub-module 5011, 3D meshes (Vₛ^{w}, Fₛ^{w}) and their bounding boxes (Vₛ^{b}, Fₛ^{b}) generated at the origin corresponding to all target vertices. The target vertices here are the H vertices identified by the candidate box generation sub-module 5011. P_{c} represents target coordinates, and P_{N} represents target normal vectors. These inputs are calculated by the candidate box generation sub-module 5011. The output may include: 3D meshes (Vₜ^{w}, Fₜ^{w}) added to each target vertex on the surface of the 3D model and corresponding candidate boxes (Vₜ^{b}, Fₜ^{b}) after the bounding boxes (Vₛ^{b}, Fₛ^{b}) are translated and rotated.

Continuing with FIG. 7C, the method can include the following steps:

S701c: initializing the 3D mesh (Vₜ^{w}, Fₜ^{w}) and corresponding candidate boxes (Vₜ^{b}, Fₜ^{b}), according to line 1.

S702c: using an angle algorithm (e.g. compute_angles) to compute the angle (αⁱ, βⁱ, γⁱ) between the top direction (0, 0, 1) of the bounding box corresponding to each target vertex (P_{C}ⁱ, P_{N}ⁱ) and the normal vector of the target direction P_{N}ⁱ. This step corresponds to line 3.

S703c: transporting the bounding box at the i^{th} sampled location P_{C}ⁱ and aligning the bounding box along its normal vector of the target direction P_{N}ⁱ by rotating the bounding box, according to line 4 and line 5. In detail, this step includes computing rotation matrix Rⁱ required for the transformation based on the angle (αⁱ, βⁱ, γⁱ) by using rotation algorithm (e.g. generate_rotation_matrix), and includes computing the translation matrix Tⁱ required for the translation operation based on the location of bounding box and the location P_{C}ⁱ of the i^{th} target vertex by using translation algorithm (e.g. compute_translation_matrix).

In some embodiments, by step S703c, the candidate box space registration sub-module 5012 can translate and rotate the bounding boxes based on the target vertices. That is to say, any point in the bounding boxes may be moved to coincide with the target vertices. The point in the bounding boxes that may be moved to coincide with the target vertices is not limited in this disclosure. For example, the point can be the centroid of the bounding box, or any other point, e.g. vertex of the bounding box.

S704c: performing the transformation operation of the 3D meshes and bounding boxes using linear matrix multiplications based on the rotation matrix and the translation matrix, to obtain candidate boxes (Vₜ^{b}, Fₜ^{b}) and 3D meshes (Vₜ^{w}, Fₜ^{w}). This step corresponds to lines 6 to 8.

In this disclosure, the candidate boxes can be obtained after the bounding boxes are translated and rotated.

It can be seen that when the centroid of the bounding box coincides with the target vertex, a part of the candidate box may enter the interior of the 3D model, and another part may be outside the 3D model after the bounding box is translated and rotated. That is to say, there may be 3D intersection between the candidate box and the 3D model.

It can be seen that, by the candidate box generation and spatial registration module 501 which is configured by the automatic visible watermark embedding system 300, the location of a set of candidate boxes on a 3D model can be determined, ensuring that the unfit vertices are removed from the 3D model first, further improving the efficiency of the automatic visible watermark embedding system 300.

In some embodiments, for the candidate box generation and spatial registration module 501 shown in FIG. 6, as shown in FIG. 7D, the candidate box generation and spatial registration module 501 can also be configured with candidate box fine-tuning sub-module 5013 that can finetune the locations and orientations of candidate boxes output by the candidate box space registration sub-module 5012 using gradient-based optimization.

By doing so, the problems of 1) poor rotation orientation around the P_{N}ⁱ axis as it is unspecified, 2) an aberrant direction of normal P_{N}ⁱ as a consequence of high local roughness, and 3) limited real estate around P_{C}ⁱ due to high local curvature can be solved. As a result of fixing these problems, the candidate boxes end up being better aligned with the surface of the model.

As shown in FIG. 7E, the candidate box fine-tuning sub-module 5013 can fix the orientation by a small amount of rotation, tilting, or moving the candidate boxes. The sub-module 5013 uses a rigid-transform optimization approach to automatically learn the necessary transform for addressing the misalignment in each of the above cases. The details of the proposed optimization objective, loss function, and learning procedure are given in the following.

### Optimization Objective

The candidate box fine-tuning sub-module 5013 can parameterize the rigid-body transformation using the rotation parameters (θ_{α}ⁱ, θ_{β}ⁱ, θ_{γ}ⁱ) and the translation (θ_{X}ⁱ, θ_{Y}ⁱ, θ_{Z}ⁱ) parameters. The former represents the rotation angles and the later represents the translation deltas along the X, Y, and Z axis, respectively. Using these parameters, the candidate boxes can be optimized by using formula (1) to formula (3).

$${arg min}_{{\{ {θ}_{α}^{i} , {θ}_{β}^{i} , {θ}_{γ}^{i} , {θ}_{X}^{i} , {θ}_{Y}^{i} {θ}_{Z}^{i} \}}_{i = 1}^{H}} \frac{1}{H} {\sum }_{i = 1}^{H} ℒ ( {\tilde{V}}_{t}^{{b}_{i}} , M ) \qquad formula ( 1 )$$

$${\tilde{V}}_{t}^{{b}_{i}} = {T}_{{C}_{X}^{i} , {C}_{Y}^{i} , {C}_{Z}^{i}} \cdot {R}_{{θ}_{α}^{i} , {θ}_{β}^{i} , {θ}_{γ}^{i}} \cdot - {T}_{{C}_{X}^{i} {C}_{Y}^{i} , {C}_{Z}^{i}} \cdot {\overline{V}}_{t}^{{b}_{i}} \qquad formula ( 2 )$$

$${\overline{V}}_{t}^{{b}_{i}} = {T}_{{θ}_{X}^{i} , {θ}_{Y}^{i} , {θ}_{Z}^{i}} \cdot {V}_{t}^{{b}_{i}} \qquad formula ( 3 )$$

In formula (1), [symbol] , V̅ₜ^{b}^{ᵢ}, and \tilde{V}ₜ^{b}^{ᵢ} are respectively the loss function, the intermediate translated vertices of the candidate box, and the intermediate rotated vertices of the candidate box. The process of optimizing candidate box using formula (1) may include: moving the vertices of i^{th} candidate box Vₜ^{b}^{ᵢ} using the translation matrix T_{θ}_{_{X}}_{ⁱ}_{,θ}_{_{Y}}_{ⁱ}_{,θ}_{_{Z}}_{ⁱ}∈ [symbol] ^{3×3}; and rotating the candidate box around centroids using the rotation matrix R_{θ}_{_{α}}_{ⁱ}_{,θ}_{_{β}}_{ⁱ}_{,θ}_{_{γ}}_{ⁱ}∈ [symbol] ^{3×3}.

In some embodiments, the translation matrix T_{C}_{_{X}}_{ⁱ}_{,C}_{_{Y}}_{ⁱ}_{,C}_{_{Z}}_{ⁱ} can be required to temporarily move the candidate box at origin (0,0,0), which can be eventually transported back to previous place (c_{X}ⁱ, c_{Y}ⁱ, c_{Z}ⁱ). Moving the candidate box temporarily to origin is required to guarantee that the candidate box is rotating around its centroid (c_{X}ⁱ, c_{Y}ⁱ, c_{Z}ⁱ) and not an arbitrary point.

### Loss Function

The loss function [symbol] (\tilde{V}ₜ^{b}^{ᵢ}, M) in formula (1) can provide an estimate of the error in alignment between the candidate box \tilde{V}ₜ^{b}^{ᵢ} and the surface of the 3D model M. In some embodiments, a kind of ideal alignment method includes that the surface of the 3D model passes through the middle of the candidate box, bisecting candidate box into half. In other words, the surface of the 3D model bisects the height of the candidate boxes, rather than length/width, to make the watermarks readable on the top/bottom faces of the candidate boxes. This ensures that the placed watermark's characters will be parallel to the surface, improving readability and security.

In some embodiments, vertices on the top face of the candidate box as t₁, t₂, t₃, and t₄, and the corresponding vertices on the bottom face of the candidate box as b₁, b₂, b₃, and b₄. Specifically, the top face can be the face of the candidate box that is parallel with a surface of the 3D model. Further, the middle points

$${m}_{1} = \frac{{b}_{1} + {t}_{1}}{2} , {m}_{2} = \frac{{b}_{2} + {t}_{2}}{2} , {m}_{3} = \frac{b 3 + t 3}{2} , and {m}_{4} = \frac{b 4 + t 4}{2}$$

can be obtained. Then equidistant points on the line segments defined by points (m₁, m₂), (m₂, m₃), (m₃, m₄), and (m₄, m₁) may be sampled, to obtain a set {sₖⁱ}ₖ₌₁^{K}, where K is the total number of points per candidate box.

The loss can be defined as the distance between these sampled points from the surface of the 3D model through the formula (4).

$$ℒ ( {\tilde{V}}_{t}^{{b}_{i}} , M ) = \frac{1}{K} {\sum }_{j = 1}^{K} D ( {s}_{j}^{i} , M ) \qquad formula ( 4 )$$

In formula (4), D is the in-built differential loss in Pytorch3D™ for computing distance between point clouds and 3D model. This loss will be minimized when all points {sₖⁱ}ₖ₌₁^{K} lie on the surface of the 3D model. That is to say, when the 3D model's surface passes through the middle of the candidate box and is parallel to the top and the bottom face, bisecting the candidate box into half, the loss can be minimized.

### Learning

The optimization objective defined in formula (1) is non-linear and non-convex. The back-propagation can be used to compute gradients and obtain the optimized parameters {\hat{θ}_{α}ⁱ, \hat{θ}_{β}ⁱ, \hat{θ}_{γ}ⁱ}ᵢ₌₁^{H} and {\hat{θ}_{X}ⁱ, \hat{θ}_{Y}ⁱ, \hat{θ}_{Z}ⁱ}ᵢ₌₁^{H} by minimizing the objective in formula (1). Consequently, the fine-tuned candidate-box vertices {Vₒ^{b}^{ᵢ}}ᵢ₌₁^{H} and the corresponding meshes {Bₒⁱ(Vₒ^{b}^{ᵢ}, Fₒ^{b}^{ᵢ})}ᵢ₌₁^{H} can be obtained. Further, in some embodiments, a large number of H candidate boxes can be placed across the body of the 3D model, to prune sub-optimal solutions by using heuristics.

In some embodiments, for the loss function in formula (4) adopted for the candidate box fine-tuning sub-module 5013, in order to ensure low-loss candidate boxes, the loss of a single candidate box can be handled with a threshold. For example: define a loss threshold of 0.005 and select a candidate box whose loss is less than the loss threshold of 0.005. Such a candidate box better aligns with the surface of the 3D model, eliminating the candidate box that is misaligned with the surface of the 3D model.

In some embodiments, the fine-tuning method mentioned above can be executed by a model (as an example of the first model). In addition, the above method can also be used to generate candidate boxes based on the bounding boxes directly, not just fine-tune the bounding boxes after translation and rotation. In other words, function of the first model can be the same as that of the combination of the candidate box space registration sub-module 5012 and fine-tuning sub-module 5013.

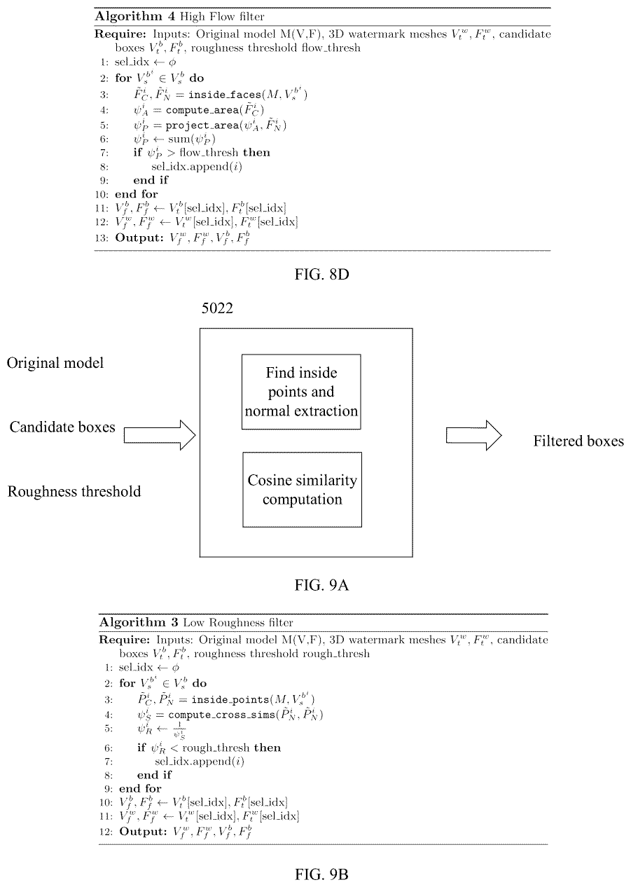

After describing the candidate box generation and spatial registration module 501 of the data processing system 300, in conjunction with FIG. 8A and FIG. 8B, the process of how the candidate box filtering module 502 obtains the target boxes from the candidate boxes on the 3D model will be described in the following.

As shown in FIG. 8A, the candidate box filtering module 502 takes the original (3D) model, candidate boxes, and parameters (e.g. watermark filtering conditions) as input, and the output is filtered boxes, which can also be called target boxes in this disclosure. The candidate boxes are filtered based on high flow sub-module 5021, low roughness sub-module 5022, non-overlap sub-module 5023, and max distance sub-module 5024. These sub-modules are applied in sequence to make sure that the final filtered boxes satisfy the filtering criteria or conditions of all these sub-modules.

As shown in FIG. 8B, the candidate boxes selected by the high flow sub-module 5021 can be better placed along the surface of the 3D model. The candidate boxes selected by the low roughness sub-module 5022 can be placed on flatter surface, ensuring better visibility. The candidate boxes selected by the non-overlap sub-module 5023 do not overlap with each other with better readability. The candidate boxes selected by the max distance sub-module 5024 are present at various subparts of the 3D model and not crowded together.

It can be seen that target boxes are selected from the candidate boxes. Thus, the target boxes have high quality. These high-quality boxes can be positioned and oriented optimally to maximize asset utility and watermark quality, thereby ensuring optimal security and visibility of the watermarks. Each sub-module will be described in the following.

The high flow sub-module 5021 is used to measure how well a placed candidate box flows along the surface of the 3D model. This sub-module can compute the flow score of each candidate box. For example, a higher score is assigned to the candidate box which is nicely blended on the surface of the 3D model and a lower score is assigned to the candidate box which is hidden into or flying out of the surface of the 3D model. Thereafter, properly oriented boxes with high flow scores are chosen and improperly oriented boxes with low flow scores are rejected using a threshold as the parameter.

Specifically, the flow score is assigned based on estimating the projected area of the 3D model covered under the candidate box.

In some embodiments, the high flow sub-module 5021 can filter the candidate boxes using the method shown in FIG. 8C. In FIG. 8C, the input consists of original model (3D model) M (V, F), candidate boxes (Vₜ^{b},Fₜ^{b}) (along with corresponding watermark meshes (Vₜ^{w},Fₜ^{w})), a parameter e.g. a flow threshold. The output consist of filtered candidate boxes (V_{f}^{b},F_{f}^{b}) whose flow score is above the flow threshold, and corresponding 3D meshes (V_{f}^{w},F_{f}^{w}).

Specifically, for the projected area of the 3D model inside the candidate box to be high, such candidate box can be selected because the candidate box spans maximum area of the surface of the 3D model. This means that the candidate box is lying flat on the 3D model and not sticking out or sticking inside the surface of the 3D model.

In this process, tagging of inside faces, area computation of located faces, and projection along the face normal vectors are needed, which will be described in conjunction with the FIG. 8D.

As shown in FIG. 8D, the method includes the following steps in detail.

S801d: initializing the sel_idx of the candidate boxes meeting the condition, according to line 1.

S802d: identifying all faces and their normal vectors (F_{C}ⁱ,F_{N}ⁱ) of the 3D model that lie inside the i^{th} candidate box (Vₜ^{b}^{ᵢ},Fₜ^{b}^{ᵢ}) by the inside_faces algorithm according to line 3. The inside faces algorithm will be provided in the following, which will not be described herein.

S803d: computing the areas ψ_{A}ⁱ of the inside faces F_{C}ⁱ. for example, if the inside faces are triangles, off-the-shelf method for computing the areas can be used. This step corresponds to line 4.

S804d: computing the projected areas ψ_{P}ⁱ of the areas «_{A}ⁱ along the corresponding normal vector F_{N}ⁱ using an off-the-shelf method (e.g. multiplies the area ψ_{A}ⁱ by the cos value of the angle between normal vector F_{N}ⁱ and normal vector of the top face of the candidate box). This step corresponds to line 5.

S805d: summing up all projected areas ψ_{P}ⁱ of the inside faces F_{C}ⁱ. This step corresponds to line 6.

S806d: if the summed areas ψ_{P}ⁱ (or taken as the average flow score) is larger than the flow threshold, selecting the candidate box (Vₜ^{b}^{ᵢ},Fₜ^{b}^{ᵢ}), and adding the candidate box into the sel_idx. This step corresponds to lines 7 to 9.

S807d: obtaining all candidate boxes (V_{f}^{b},F_{f}^{b}) meeting the condition and corresponding 3D meshes (V_{f}^{w},F_{f}^{w}). This step corresponds to lines 10 to 11.

In content mentioned above, the inside faces can be examples of the first faces. And the projected areas of the inside faces can be examples of the first projected areas.

The low roughness sub-module 5022 is used to compute a roughness score of the surface of the 3D model under the candidate box. For example, a lower roughness score indicates that the surface around a given point is relatively flat and such point for watermark placement is preferred to boost the visibility of the watermarks. Thereafter, the candidate boxes that are placed at flatter areas with low roughness score may be selected and candidate boxes that are placed at rough areas with high roughness score may be removed using a roughness threshold as a parameter.

Specifically, the roughness score around a given point is computed by calculating the average pair-wise cosine similarity between normal vectors of a local area around that point.

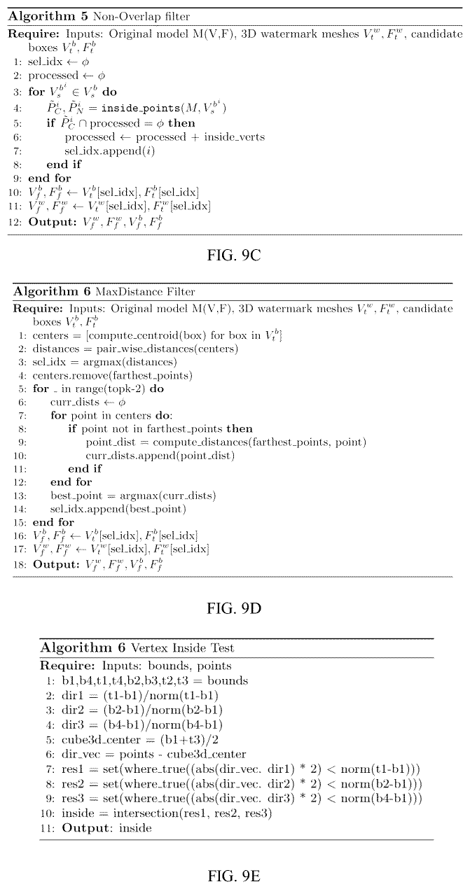

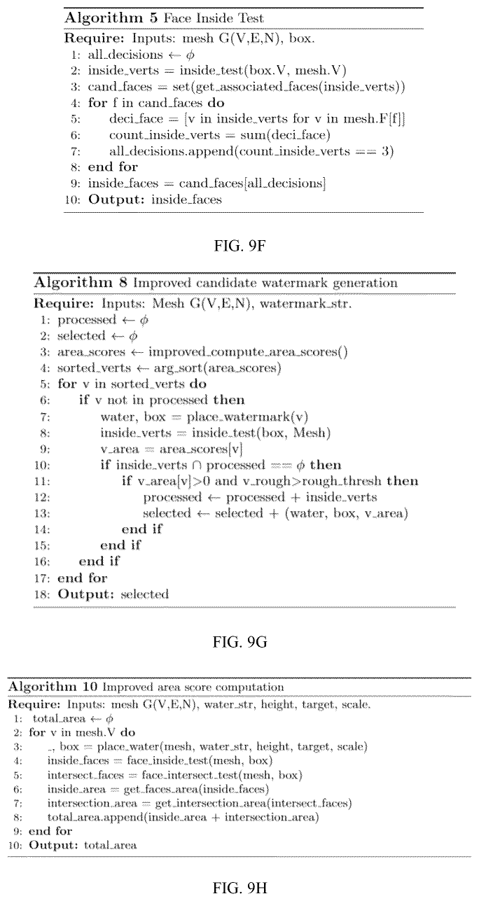

In some embodiments, the low roughness sub-module 5022 can filter the candidate boxes using the method shown in FIG. 9A. In FIG. 9A, the input consists of original model (3D model) M (V, F), candidate boxes (Vₜ^{b},Fₜ^{b}) (along with corresponding watermark meshes (Vₜ^{w},Fₜ^{w})), a parameter e.g. a roughness threshold. The output consists of filtered candidate boxes (V_{f}^{b},F_{f}^{b}) whose roughness score is lower than the roughness threshold, and corresponding 3D meshes (V_{f}^{w},F_{f}^{w}).

In this process, the determination of inside points and normal (vector) extraction, as well as cosine similarity computation are needed, which will be described in conjunction with the FIG. 9B.

As shown in FIG. 9B, the method includes the following steps in detail.

S901b: initializing the sel_idx of the candidate boxes meeting the condition, according to line 1.

S902b: identifying all points and their normal vectors (P_{C}ⁱ, P_{N}ⁱ) of the 3D model that lie inside the i^{th} candidate box (Vₜ^{b}^{ᵢ},Fₜ^{b}^{ᵢ}) by the inside_points algorithm according to line 3. The inside_points algorithm will be provided in the following, which will not be described herein.

S903b: computing cosine similarities ψ_{S}ⁱ between all extracted normal vector P_{N}ⁱ, according to line 4.

S904b: taking the inverse 1/ψ_{S}ⁱ of the average of the cosine similarities ψ_{S}ⁱ as the roughness score ψ_{R}ⁱ, according to line 5. Flatter areas have higher cosine similarity, hence lower roughness score. Uses cosine similarity algorithm to compute cosine similarity scores between all points and return the mean score.

S905b: If the computed average roughness score is lower than the roughness threshold, selecting the candidate box (Vₜ^{b}^{ᵢ},Fₜ^{b}^{ᵢ}), and adding the candidate box into the sel_idx. This step corresponds to lines 6 to 8.

S906b: obtaining all candidate boxes (V_{f}^{b},F_{f}^{b}) meeting the condition and corresponding 3D meshes (V_{f}^{w},F_{f}^{w}). This step corresponds to lines 10 to 11.

In some embodiments, top K₁ candidate boxes from the list of candidate boxes output by the high flow sub-module 5021 can be selected. Similarly, top K₁ candidate boxes from the list of candidate boxes output by the low roughness sub-module 5022 can be selected. Or when sub-module 5021 and 5022 are both deployed, top K₁ candidate boxes can be selected from the list of candidate boxes output by sub-module 5021 and 5022.

No matter which case above, that is to say, not all candidate boxes meeting the flow condition and/or roughness will be selected.

In some other embodiments, the flow threshold and/or the roughness threshold can be percentage-based to select top K₁ candidate boxes.

The non-overlap sub-module 5023 is used to compute whether a candidate box overlaps with other candidate boxes or not. If so, the candidate boxes that overlap with each other may be removed. That is to say, the selected candidate boxes should not overlap with each other for better visual appear, readability and asset utility.

In some embodiments, the non-overlap sub-module 5023 can filter the candidate boxes using the method shown in FIG. 9C. In FIG. 9C, the input consists of original model (3D model) M (V, F), candidate boxes (Vₜ^{b},Fₜ^{b}) (along with corresponding watermark meshes (Vₜ^{w},Fₜ^{w}). The output consists of filtered candidate boxes (V_{f}^{b}, F_{f}^{b}) that have no overlap with each other, and corresponding 3D meshes (V_{f}^{w},F_{f}^{w}).

It can be understood that if the candidate boxes overlap with each other, then watermarks will also overlap with each other, which may affect readability and asset utility of the 3D model.

The non-overlap sub-module 5023 can adopt a greedy approach, start by choosing a random candidate box and iteratively remove any candidate box overlapped with the chosen candidate box. In order to compute overlap, checking for any intersection between the vertices of the 3D model that are inside a pair of candidate boxes can be adopted.

Continuing with the FIG. 9C, the method includes the following steps in detail.

S901c: initializing processed and selected idx (sel_idx) as empty lists according to line 1.

S902c: identifying the vertices P_{C}ⁱ of 3D model which lie inside the i^{th} candidate box (Vₜ^{b}^{ᵢ}, Fₜ^{b}^{ᵢ}) by the inside_points algorithm according to line 4. The inside_points algorithm will be provided in the following, which will not be described herein.

S903c: making sure that no vertex P_{C}ⁱ that is in the current candidate box (in loop) is already present in the processed array. This step corresponds to line 5.

S904c: if the intersection is empty, adding the selected candidate box (Vₜ^{b}^{ᵢ}, Fₜ^{b}^{ᵢ}) into the selected list sel_idx and add the corresponding vertices into processed list. This step corresponds to lines 6 to 7.

S905c: obtaining all candidate boxes (V_{f}^{b},F_{f}^{b}) meeting the condition and corresponding 3D meshes (V_{f}^{w},F_{f}^{w}). This step corresponds to lines 10 to 11.

The max distance sub-module 5024 is used to compute the distance between candidate boxes, and filters candidate boxes meeting distance condition. For example, the distance condition can be distance between candidate boxes is larger than a second distance threshold, or the top K₂ number of all candidate boxes with max distance. By doing so, candidate boxes can be placed at various subparts locations of the 3D model rather than crowding at a certain location.

In some embodiments, the max distance sub-module 5024 can filter the candidate boxes using the method shown in FIG. 9D. In FIG. 9D, the input consists of original model (3D model) M (V, F), candidate boxes (Vₜ^{b},Fₜ^{b}) (along with corresponding watermark meshes (Vₜ^{w},Fₜ^{w})), a parameter e.g. top K₂ number of selected candidate boxes. The output consists of filtered top K₂ number of candidate boxes (V_{f}^{b},F_{f}^{b}) that are at maximum distance from each, and corresponding 3D meshes (V_{f}^{w},F_{f}^{w}).

Continuing with the FIG. 9D, the method includes the following steps in detail.

S901d: computing the centroids of the candidate boxes (Vₜ^{b},Fₜ^{b}), according to line 1.

S902d: computing pair-wise distances between all centroids of the candidate boxes, according to line 2.

S903d: choosing two candidate boxes whose centroids are farthest from each other and removing them from the consideration list to indicate that they have been chosen already.

S904d: looping to select the remaining top K₂ candidate boxes, according to line 5.

S905d: looping over all remaining centroids of candidate boxes and computing distance from the list of chosen points that are the farthest from chosen points (sel_idx). This step corresponds to lines 7 to 11.

S906d: choosing the candidate boxes which are at the greatest aggregate distance from the centroids of all chosen candidate boxes so far. This step corresponds to line 13.

S907d: selecting candidate boxes and watermark meshes corresponding to selected indices (sel_idx).

The inside points algorithm and inside_faces algorithm involved in the high flow sub-module 5021 low roughness sub-module 5022 are described below.

In some embodiments, the inside_points algorithm involved in the low-roughness sub-module 5022 is used to identify the vertices and surface normal vectors of a 3D model inside a candidate box, where, the input includes: bounds and points. Bounds represent the bottom left and top right coordinates of the candidate box in 3D space. Points represent the 3D points to be tested, which are the vertices of the 3D model. The output of the inside_points algorithm includes decision on whether the points are inside or outside the candidate box.

As shown in FIG. 9E, the inside points algorithm includes the following steps.

S901e: calculating the vectors along the three directions of the candidate box: dir1, dir2 and dir3 in line 2 to line 4.

S902e: calculating the centroid of the bounding box cube3d_center, and the cube3d_center equals (b1+t3)/2 in line 5.

S903e: calculating vectors dir_vec from the centroid of the candidate box to all points in line 6.

S904e: checking whether the projection of vectors dir_vec is within the candidate box in line 7 to line 9.

S905e: If all projections are within the bounds of the candidate box, the points are inside the candidate box. If not, the points are outside.

The inside_faces algorithm involved in the high flow sub-module 5021 is used to identify all the faces of the 3D model inside the candidate box. The output of the inside_faces algorithm includes: the 3D model G (V, E, N) and candidate box (of the watermarks under consideration). The output of the inside_faces algorithm includes: the faces with all vertices inside the candidate box.

As shown in FIG. 9F, the inside_faces algorithm includes the following steps.

S901f: initializing an empty list (e.g. all_decisions) to collect results in line 1.

S902f: computing all vertices of the 3D model which lie inside the candidate box using the inside_points algorithm shown in S501g to S505g, to obtain inside_verts. This step corresponds to line 2.

S903f: getting all faces (cand_faces) which have at least one vertex in the inside_verts computed in S502h.

S904f: for each face in cand_faces, identifying how many vertices corresponding to the face are in the inside_verts, to determine whether the face (with at least one vertex inside) is partially inside or completely inside.

S905f: if all three vertices of the face are inside, adding the face to the selected list all_decisions.

In some embodiments, the high flow sub-module 5021 adopts an approximation area computation method which only considers faces that lie completely inside the candidate box to filter the candidate box. The method does not consider the faces which lie partially inside and/or partially outside the candidate box.

Although the method can identify the candidate box in a relatively short time, the quality of the candidate box may be not optimal. Therefore, another kind of method to filter the candidate boxes by high flow sub-module 5021 is shown in FIG. 9G, which can improve the visibility of the candidate box.

As shown in FIG. 9G, the input can include: the 3D model, candidate boxes (and corresponding 3D meshes). The output includes a list including the selected candidate boxes through the flow score. Specifically, the 3D model can be represented as G (V, E, N), where V is a set of vertices, E is a set of edges and N is a set of normal vectors.

S901g: initializing two empty lists including the processed and the selected in line 1 and line 2.

S902g: computing area scores of candidate boxes using the improved_compute_area_scores algorithm in line 3. The improved_compute_area_scores algorithm will be described in the following content.

S903g: sorting the area scores and get the corresponding vertices (e.g. sorted_verts) in line 4.

S904g: iterating over the sorted vertices in sorted_verts in line 5.

S905g: proceeding if a vertex in not in processed in line 6.

And the iterating process can include:

S906g: obtaining the 3D meshes and corresponding candidate box in line 7.

S907g: calculating the vertices of 3D model which lie inside the candidate box in line 8.

S908g: calculating the area score of the vertex v in line 9.

S909g: if all vertices of the 3D model in candidate box are not in processed array in line 10, S510i is conducted.

S910g: thresholding to make sure area scores satisfy a certain criterion to be selected as a candidate box.

S911g: adding the selected candidate box into the selected list and adding the corresponding vertices into processed list.

The improved_compute_area_scores algorithm is described in the following.

In some embodiments, the input of the improved_compute_area_scores algorithm can include: the 3D model G (V, E, N), watermark string, height (or thickness) of the candidate boxes, target vertices corresponding to candidate boxes, and scale (or size) of the candidate boxes. The output can include the flow scores of all vertices.

S901h: initializing the flow scores (e.g. total_area) in line 1.

S902h: iterating over all target vertices of the 3D model in line 2.

S903h: for target vertex v, generating 3D watermark bounding box and place the bounding box on the target vertex v in line 3, to obtain candidate box.

S904h: identifying the faces of the 3D model which lie completely inside the candidate box in line 4.

S905i: identifying the faces of the 3D model which lie partially inside the candidate box in line 5 by using the intersect_faces algorithm.

S906h: computing the projected area of faces which lie completely inside the long face of the candidate box in line 6.

S907h: computing the projected area of faces which lie partially inside the long face of the candidate box in line 7.

S908h: appending the sum of the projected area to the total_area list in line 8.

S909h: looping until all target vertices are covered in set V, to obtain flow scores corresponding to all target vertices in line 9.

The above intersect_faces algorithm is used to identify the faces of the 3D model that are partially inside the candidate boxes. The input of the intersect_faces algorithm can include: 3D model G (V, E, N) and candidate boxes. The output of the algorithm can include: the faces with vertices partially inside the candidate boxes.

Referring to FIG. 9I, the intersect_faces algorithm can include the following steps.

S901i: initializing an empty list (e.g. all_decisions) to collect results in line 1.

S902i: computing all vertices of the 3D model which lie inside the candidate box using the inside_points algorithm shown in S501g to S505g, to obtain inside_verts. This step corresponds to line 2.

S903i: getting all faces (cand_faces) which have at least one vertex in the inside_verts computed in S902i.

S904i: for each face in cand_faces, identifying how many vertices corresponding to the face are in the inside_verts, to determine whether the face (with at least one vertex inside) is partially inside.

S905i: if there are more than zero and less than three vertices inside, adding the face to the selected list all_decisions in line 7.

It can be understood that the above four sub-modules in the candidate box filtering module 502 are optional. That is to say, the candidate box filtering module 502 can have at least one of the four sub-modules. And the operation order of the at least one of the four sub-modules is not limited in this disclosure. For more than one sub-module, the input candidate boxes of the latter sub-module are the candidate boxes output by the former sub-module, and the candidate boxes output by the last sub-module can be the target boxes in this disclosure.

This candidate box filtering module 502 select target boxes that meet corresponding conditions, ensuring that the target boxes have optimal locations and orientation, maximizing the asset utility and watermark quality for security and visibility.

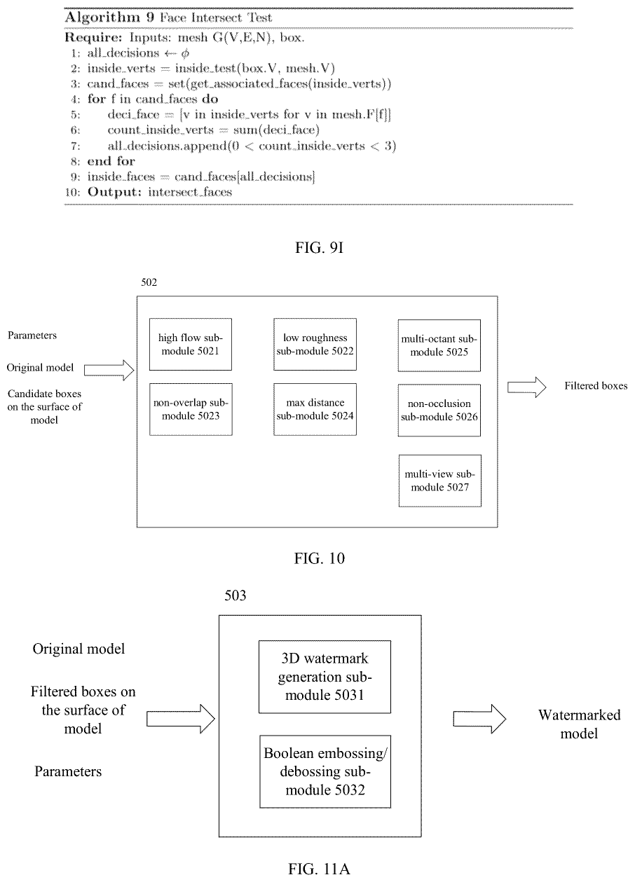

In some embodiments, as shown in FIG. 10, the candidate box filtering module 502 can further include multi-octant sub-module 5025, non-occlusion sub-module 5026 and multi-view sub-module 5027.

In some embodiments, multi-octant sub-module 5025, non-occlusion sub-module 5026 and multi-view sub-module 5027 can be configured after the high flow sub-module 5021, low roughness sub-module 5022, non-overlap sub-module 5023 and max distance sub-module 5024, to filter the candidate boxes further, and obtain the target boxes. In other embodiments, there is no operation order between multi-octant sub-module 5025, non-occlusion sub-module 5026 and multi-view sub-module 5027, and there is also no operation order between these three sub-modules with other sub-modules (e.g. sub-modules 5021, 5022, 5023, and 5024). Each sub-module mentioned above can combine with each other to filter the candidate boxes to obtain target boxes, which is not limited in this disclosure.

The multi-octant sub-module 5025, non-occlusion sub-module 5026 and multi-view sub-module 5027 will be described in detail in the following.

The multi-octant sub-module 5025 can be used to divide the 3D model into 8 octants (or subparts) by cutting the 3D model using X, Y, and Z places passing through the centroid of the 3D model, to select at least one candidate boxes for each subpart. The three planes can be the XOZ, XOY, and YOZ planes passing through the centroid of the 3D model, or any planes parallel to the above planes. The subpart can be an example of the target part.

The at least one candidate boxes for each subpart can be determined by distance. For example, if there are multiple candidate boxes per subpart, the at least one candidate boxes which have maximum distance from the ones in other subparts can be selected. By doing so, the candidate boxes can be placed at various distant parts of the 3D model, preventing illegal use of the 3D model and improving the security of the 3D model with watermarks.

The non-occlusion sub-module 5026 is used to remove some candidate boxes with poor visibility. For instance, in case of a humanoid model, the watermarks/candidate boxes under the arms or between the thighs have poor visibility, so such candidate boxes may be removed. The non-occlusion sub-module 5026 can use a ray casting method. Specifically, multiple equidistant points from the top face of the candidate boxes are sampled and rays towards the normal vector of the respective candidate boxes are casted, where a viewing direction towards the top face can be an example of the first view. If any of the casted rays are intercepted by some part of the 3D model, the candidate box is considered to be occluded and this candidate box can be removed or not selected.

The multi-view sub-module 5027 is used to select at least one candidate box on the 3D model for each viewing angle (as an example of a first viewing angle). Since there are infinite viewing angles for a 3D model, a list of fixed angle increments of around the X and Z axis can be adopted, e.g. an increment of 30°, to ensure at least one candidate box is on the surface of the 3D model for each viewing angle. By doing so, the 2D renders of a 3D model obtained on different viewing angles where no watermarks/candidate boxes are visible can be prevented, thus improving the security of the candidate boxes, even the security of the 3D model with watermarks.

After the target boxes are outputted by the candidate box filtering module 502, watermarks may be embedded (or added, or etched) to the surface of the 3D model by the watermark generation and fusion module 503. Specifically, watermarks may be generated based on the target boxes, and the watermarks may also be embossed or debossed to the 3D model, to obtain the 3D model with watermarks.

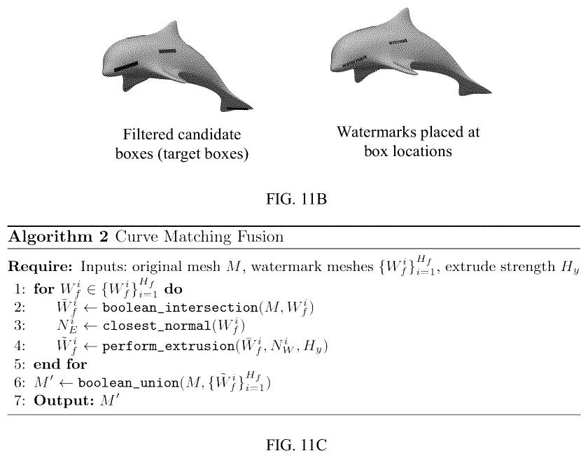

As shown in FIG. 11A, the input of the watermark generation and fusion module 503 can include the 3D model M (V, E, N), filtered boxes on the surface of the model (or the target boxes), and parameters. And the output can include the 3D model with watermarks (or watermarked model) where the watermarks are etched into the geometry of the model.

As shown in FIG. 11B, there is comparison between the 3D model with filtered candidate boxes (target boxes) and the 3D model with watermarks placed at (target) box locations.

In FIG. 11A, the watermark generation and fusion module 503 includes two sub-modules, which are 3D watermark generation sub-module 5031 and Boolean embossing/debossing sub-module 5032.

The 3D watermark generation sub-module 5031 can be used to generate actual 3D-text watermarks (meshes) at locations corresponding to the target boxes. In detail, after the target boxes are determined, better locations and orientations for placing the watermarks on the surface of the 3D model are also determined. So, the watermarks can be embedded to the locations of the target boxes.

The Boolean embossing/debossing sub-module 5032 can be used to embed the watermarks into the surface of the 3D model. Specifically, the watermarks at locations corresponding to the target boxes on the surface of the 3D model are still separate disconnected objects (i.e., characters) that are not merged into the geometry of the 3D model. Therefore, it is easy to identify vertices and faces of the model and remove them to obtain the original 3D model. In detail, this sub-module 5032 adopts Boolean merging operations (or Boolean fusion) provided by Blender™, like Boolean union or Boolean difference to create an embossing or debossing effect of the watermarks.

In addition, the Boolean fusion can be either embossing or debossing. In the embossed mode, the fusion is performed using a 3D union operation between the 3D-text watermark meshes and the 3D model. By doing so, a raised text on top of the surface of the 3D model is generated. On the other hand, the debossed mode performs fusion using a 3D Boolean difference between the watermark meshes and the 3D model. By doing so, a reduced/lowered text into the surface of the 3D model is generated.

By using the watermark generation and fusion module 503, the watermarks placed are inseparable from the surface and are placed irreversibly on the geometry (vertices and faces) of the 3D model, which are hard to remove, thus improving the security of the 3D model with watermarks.

After embedding the watermarks into the 3D model as shown in FIG. 11A, the watermarks may not follow the local curvature of the surface of the 3D model, because the curvature of the surface of the 3D model is not considered. That is to say, a flat textual surface of the watermarks will be created on the curved surface of the 3D model, which affects the visual quality (utility) of the watermarked 3D model.

Therefore, in some embodiments, a curve-matching fusion method executed by a curve-matching Boolean embossing/debossing sub-module is introduced in this disclosure. That is to say, the curve-matching Boolean embossing/debossing sub-module can replace the Boolean embossing/debossing sub-module 5032 mentioned above. The curve-matching Boolean embossing/debossing sub-module can be used to make the watermarks follow the local curvature of the surface of the 3D model.

Specifically, the curve-matching fusion method of the curve-matching Boolean embossing/debossing sub-module can include the following steps. First, an intersection between the 3D model and 3D-text watermark can be obtained. All vertices of the intersection result in the direction of the watermark normal vector can be extruded by a fixed distance. Finally, the Boolean union and difference operation for embossing or debossing can be used.

It can be seen that before the watermarks are embedded into the 3D model, the curve-matching fusion method is used to adjust the vertices of the 3D model that intersects with the (target) watermark meshes, to make the vertices keep a preset fixes distance from the surface of the 3D model. By doing so, the watermark meshes are enabled to follow the local curvature of the surface of the 3D model, to obtain watermarked model after being adjusted.

This method creates new and improved watermarks that follow the local curvature as they have a fixed distance from the intersection surface, improving the visual quality of the watermarked 3D model.

Referring to FIG. 11C, the input of the curve-matching Boolean embossing/debossing sub-module can include 3D model mesh M, watermark meshes {W_{f}ⁱ}ᵢ₌₁^{H}^{_{f}} and extrude strength (or pre-set fixed distance) H_{y}.

The curve-matching fusion method can include the following steps.

S1101c: for a watermark mesh W_{f}ⁱ, a Boolean intersection operation between the 3D model mesh M and the watermark mesh W_{f}ⁱ is adopted to obtain an intersection W̅_{f}ⁱ in line 1 and line 2.

S1102c: obtaining the normal vector N_{E}ⁱ by computing the normal vector of the closest point on the 3D model from the centroid of watermark mesh W_{f}ⁱ in line 3.

S1103c: extruding the intersection W̅_{f}ⁱ for a fixed distance (as an example of the first distance) H_{y} towards the direction of the normal vector N_{E}ⁱ in line 4.

S1104c: taking a Boolean union of the extruded watermark mesh W_{f}ⁱ and the 3D model mesh M to obtain the final watermarked 3D model M′ in line 6.

That is to say, after determining the intersection face of the 3D model mesh and the watermark mesh, each vertex in the intersection face can be moved for a first distance along normal vectors of corresponding target watermark mesh, to obtain a new target watermark mesh. Then the Boolean union can be used to fuse the 3D model mesh and the new target watermark mesh to obtain a watermarked target object.

The disclosure relates to an automatic visible watermark embedding system 300 which can bring the following beneficial effects.

Firstly, the system 300 can automatically identify the locations (or candidate boxes) (specifically coordinates of vertices in 3D), where the watermark can be embedded. The system 300 chooses locations to boost the visibility of watermark and reduce clutter. For instance, flat surfaces are preferred over highly complicated or rough surfaces since a text watermark placed on rough surfaces might suffer from poor visibility.

Secondly, after a set of candidate locations (or candidate boxes) has been selected, the system can further make sure that each watermark must have the correct orientation and is nicely blended into the surface of the 3D model. For instance, the watermark must not be occluded by features of the original model or flying out in random directions from the surface of the 3D model. It should flow nicely along the surface.

Thirdly, the system also ensures that the watermarks are not too crowded together and are instead placed evenly throughout the surface of the 3D model as much as possible. Further, the watermarks should not overlap with each other and should be visible from multiple viewing angles. This may result in high watermark quality and high security.

Fourthly, the placed watermarks can follow the local curvature of the underlying surface for best visual appeal. And the watermark can be embedded while preserving the texture of the 3D model. What's more, the watermarks on the 3D model in this disclosure cannot be easily removed because the watermarks are merged into the 3D model in an irreversible way using Boolean operation.

It can be seen that when describing the data processing method involved in this disclosure, an English text watermark is taken as an example, but the data processing method can also be extended to any language text, logo or image watermark embedded on the surface of the 3D model.

It can be seen that, although this disclosure describes an integral visible watermark embedding system, a variety of implementation of embedding watermarks can also be covered by changing the processing process of one or more functional modules in the visible watermark embedding system. For example, graph neural networks (GNN) can be used to locate regions where visible watermarks are embedded by means of monitoring or self-monitoring.

In addition, the algorithm in this disclosure is simplified by means of pseudo-code representation and shall be considered only as an illustration. Any changes to the algorithm, such as improving the execution efficiency of the algorithm without changing the processing results of the algorithm, shall also be considered as an implementation of this disclosure.

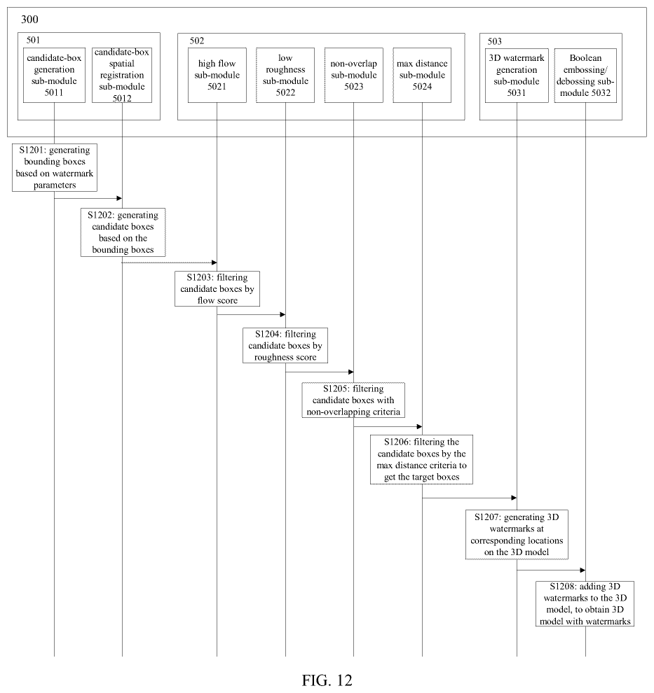

After describing each module and sub-module of the data processing system 300 in this disclosure, the interaction process of each module and sub-module is described in the following in conjunction with FIG. 12.

As shown in FIG. 12, the input may include, a 3D model, watermark parameters, and watermark filtering conditions. The output can include the watermarked 3D model. The process may include the following steps.

S1201: the candidate box generation sub-module 5011 generates bounding boxes at the origin in 3D spatial coordinates based on watermark parameters.

For example, in some embodiments, the candidate box generation sub-module 5011 can generate bounding boxes suitable for a watermark based on watermark parameters (e.g. size and thickness of watermarks). The method to generate bounding boxes is shown in FIG. 7B, which will not be described in detail herein again.

S1202: the candidate box space registration sub-module 5012 generates corresponding candidate boxes based on the bounding boxes.

For example, in some embodiments, the candidate box space registration sub-module 5012 can obtain candidate boxes by translating and rotating the bounding boxes on the 3D model based on the candidate box space registration method shown in FIG. 7C, which will not be described in detail herein again.

S1203: high-flow sub-module 5021 filters candidate boxes by flow score.

For example, in some embodiments, the high flow sub-module 5021 can estimate the flow degree of the candidate boxes on the surface of the 3D model, and determine the corresponding flow score of the candidate boxes. The decision of whether removing the candidate boxes is made by comparing the flow score and the flow threshold. The high flow sub-module 5021 can implement filtering of candidate boxes based on the high flow filtering method shown in FIG. 8D, which will not be described in detail herein again.

S1204: low roughness sub-module 5022 filters candidate boxes by roughness score.

For example, in some embodiments, the low roughness sub-module 5022 can obtain a roughness score for the surface of the 3D model corresponding to the candidate boxes. The results of the comparison between the roughness score and the roughness threshold are used to determine whether the candidate boxes should be removed, which means not selected. The low roughness sub-module 5022 can filter candidate boxes based on the roughness filtering method shown in FIG. 9B, which will not be described in detail herein again.

S1205: non-overlap sub-module 5023 filters candidate boxes with non-overlapping criteria/condition.

For example, in some embodiments, non-overlap sub-module 5023 can remove the candidate boxes overlapping with each other. The non-overlap sub-module 5023 can implement filtering of candidate boxes based on the non-overlap filtering method shown in FIG. 9C, which will not be described in detail herein again.

S1206: max distance sub-module 5024 filters the candidate boxes by the max distance criteria/condition to get the target boxes.

For example, in some embodiments, the max distance sub-module 5024 is used to calculate the distance between candidate boxes, identifying candidate boxes that meet the distance criteria and select them as target boxes. The max distance sub-module 5024 can filter the candidate boxes and get the target boxes based on the max distance filtering method shown in FIG. 9D, which will not be described in detail herein again.

S1207: 3D watermark generation sub-module 5031 generates 3D watermarks at corresponding locations on the 3D model.

For example, in some embodiments, the 3D watermark generation sub-module 5031 can generate a 3D watermark according to watermark parameters, such as watermark size, watermark text, and so on.

S1208: Boolean embossing/debossing sub-module 5032 embeds 3D watermarks to the 3D model.

For example, in some embodiments, the 3D watermark generation sub-module 5032 is used to emboss or deboss the 3D watermarks to the 3D model by the Boolean operation.

After that, the 3D model with watermarks can be obtained.

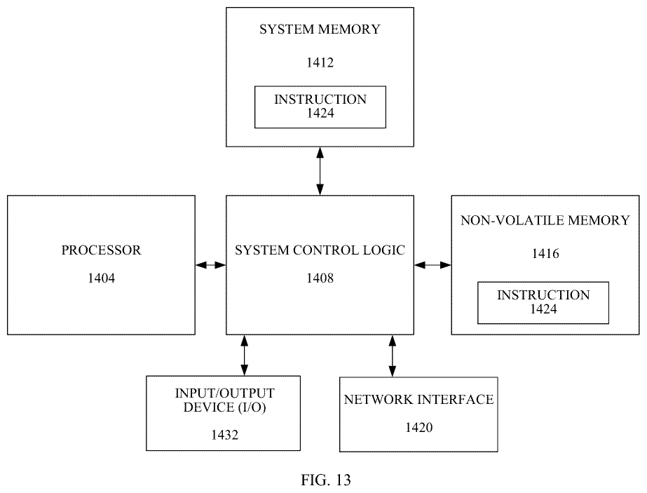

FIG. 13 shows a schematic structural diagram of an apparatus 1400 according to an embodiment of the present disclosure. In one embodiment, the apparatus 1400 may include one or more processors 1404, system control logic 1408 coupled to at least one of the processors 1404, system memory 1412 coupled to the system control logic 1408, non-volatile memory (NVM) 1416 coupled to the system control logic 1408, and a network interface 1420 coupled to the system control logic 1408.

In some embodiments, the processors 1404 may include one or more single-core or multi-core processors. In some embodiments, the processors 1404 may include any combination of general-purpose processors and special purpose processors (e.g., graphics processors, disclosure processors, baseband processors, etc.). In embodiments where the apparatus 1400 employs an eNB (Evolved Node B) 101 or a RAN (Radio Access Network) controller 102, the processors 1404 may be configured to perform various compliant embodiments, such as one or more of the various embodiments shown in FIG. 3 to FIG. 12.

In some embodiments, the system control logic 1408 may include any suitable interface controller to provide any suitable interface to at least one suitable device or component of the processors 1404 that may communicate with the system control logic 1408.

In some embodiments, the system control logic 1408 may include one or more memory controllers to provide interfaces to the system memory 1412. The system memory 1412 may be used to load and store data and/or instructions. The memory 1412 of apparatus 1400 may include any suitable volatile memory, such as a suitable dynamic random-access memory (DRAM), in some embodiments.

The NVM/memory 1416 may include one or more tangible, non-transitory computer-readable media for storing data and/or instructions. In some embodiments, the NVM/memory 1416 may include any suitable non-volatile memory, such as flash memory, and/or any suitable non-volatile storage device, such as at least one of an HDD (Hard Disk Drive), a CD (Compact Disc) drive, and a DVD (Digital Versatile Disc) drive.

The NVM/memory 1416 may include a portion of storage resources on the device on which the apparatus 1400 is installed, or it may be accessed by, but not necessarily part of, the device. For example, the NVM/storage 1416 may be accessed over the network via the network interface 1420.

In particular, the system memory 1412 and NVM/memory 1416 may include a temporary copy and a permanent copy of instruction 1424, respectively. The instructions 1424 may include instructions that, when executed by at least one of the processors 1404, cause the apparatus 1400 to implement the methods shown in FIG. 3 to FIG. 12. In some embodiments, instructions 1424, hardware, firmware, and/or software components thereof may additionally/alternatively be placed in system control logic 1408, network interface 1420, and/or processors 1404.

The network interface 1420 may include a transceiver for providing a radio interface for apparatus 1400 to communicate with any other suitable device (e.g., front-end module, antenna, etc.) via one or more networks. In some embodiments, the network interface 1420 may be integrated with other components of system 1400. For example, the network interface 1420 may be integrated with at least one of the followings: a system memory 1412, a NVM/memory 1416, and a firmware device (not shown). When the instructions are executed by at least one of the processors 1404, the apparatus 1400 can realize the methods shown in FIG. 2.

The network interface 1420 may further include any suitable hardware and/or firmware to provide a multiple-input multiple-output radio interface. For example, the network interface 1420 may be a network adapter, a wireless network adapter, a telephone modem, and/or a wireless modem.

In one embodiment, at least one of the processors 1404 may be packaged together with logic for one or more controllers of the system control logic 1408 to form a system SiP. In one embodiment, at least one of the processors 1404 may be integrated on the same die with logic for one or more controllers of the system control logic 1408 to form a system-on-chip (SoC).

The apparatus 1400 may further include an input/output (I/O) device 1432. The I/O device 1432 may include a user interface to enable a user to interact with the system 1400. The peripheral component interface is designed so that the peripheral component can also interact with the apparatus 1400. In some embodiments, the system 1400 further includes a sensor for determining at least one of environmental conditions and location information associated with the apparatus 1400.

In some embodiments, the user interface may include, but is not limited to, a display (e.g., a liquid crystal display, a touch screen display, etc.), a speaker, a microphone, one or more cameras (e.g., still image cameras and/or cameras), a flashlight (e.g., a light emitting diode flash), and a keyboard.

In some embodiments, peripheral component interfaces may include, but are not limited to, non-volatile memory ports, audio jacks, and power interfaces.

In some embodiments, the sensors may include, but are not limited to, gyroscope sensors, accelerometers, proximity sensors, ambient light sensors, and positioning units. The positioning unit may also be part of or interact with the network interface 1420 to communicate with components of the positioning network (e.g., a Global Positioning System (GPS) satellite).

As used herein, the term “module” may refer to or include, an application specific integrated circuit (ASIC), an electronic circuit, a processor (shared, dedicated, or group) and/or memory that executes one or more software or firmware programs, a combinational logic circuit, and/or other suitable hardware components that provides the described functionality. What's more, the term “module” may also be part of these hardware components.

It will be appreciated that in various embodiments of the present disclosure, the processor may be a microprocessor, a digital signal processor, a microcontroller, or the like, and/or any combination thereof. According to another aspect, the processor may be a single-core processor, a multi-core processor, or the like, and/or any combination thereof.

The embodiments disclosed herein may be implemented in hardware, software, firmware, or a combination of these implementations. Embodiments of the present disclosure may be implemented as a computer program or program code executing on a programmable system including at least one processor, a storage system (including volatile and non-volatile memory and/or storage elements), at least one input device, and at least one output device.

Program code may be applied to the input instructions to perform the functions described herein and to generate output information. The output information may be applied to one or more output devices in a known manner. For purposes of this disclosure, a processing system includes any system with a processor such as, a digital signal processor (DSP), a microcontroller, an application specific integrated circuit (ASIC), or a microprocessor.

The program code may be implemented in a high-level programming language or an object-oriented programming language to communicate with the processing system. The program code may also be implemented in assembly language or machine language, if desired. Indeed, the mechanisms described herein are not limited in scope to any particular programming language. In either case, the language may be a compilation language or an interpretation language.

In some cases, the disclosed embodiments may be implemented in hardware, firmware, software, or any combination thereof. The disclosed embodiments may also be implemented as instructions carried by or stored on one or more temporary or non-temporary machine-readable (e.g., computer-readable) storage media, which may be read and executed by one or more processors. For example, the instructions may be distributed through a network or through other computer-readable media. Thus, a machine-readable medium may include any mechanism for storing or transmitting information in a form readable by a machine (e.g., a computer), including, but not limited to, a floppy disk, an optical disk, an optical disk, a read-only memory (CD-ROMs), a magneto-optical disk, a read-only memory (ROM), a random access memory (RAM), an erasable programmable read-only memory (EPROM), an electrically erasable programmable read-only memory (EEPROM), a magnetic or optical card, a flash memory, or a tangible machine-readable memory for transmitting information (e.g., a carrier wave, an infrared signal, a digital signal, etc.) in an electrical, optical, acoustic, or other form of propagated signal using the Internet. Thus, a machine-readable medium includes any type of machine-readable medium suitable for storing or transmitting electronic instructions or information in a form readable by a machine (e.g., a computer).

In the drawings, some structural or methodological features may be shown in a particular arrangement and/or sequence. However, it should be understood that such a particular arrangement and/or ordering may not be required. Rather, in some embodiments, these features may be arranged in a manner and/or sequence different from that shown in the illustrative drawings. In addition, the inclusion of structural or methodical features in a particular figure is not meant to imply that such features are required in all embodiments. And in some embodiments, such features may not be included or may be combined with other features.

It should be noted that each unit/module mentioned in each device embodiment of the present disclosure is a logical unit/module. Physically, a logical unit/module may be a physical unit/module, may be a part of a physical unit/module, or may be implemented in a combination of a plurality of physical units/modules. The physical implementation of these logical units/modules is not the most important. The combination of functions implemented by these logical units/modules is the key to solving the technical problem proposed in the present disclosure. Furthermore, in order to highlight the inventive part of the present disclosure, the above-mentioned device embodiments of the present disclosure do not introduce units/modules which are not closely related to solving the technical problems set forth in the present disclosure, which does not indicate that the above-mentioned device embodiments do not have other units/modules.

It is to be noted that in the examples and description of this disclosure, relational terms such as first and second etc. are used solely to distinguish one entity or operation from another entity or operation, and do not necessarily require or imply any such actual relationship or order between such entities or operations. Moreover, the terms “comprises”, “comprising” or any other variation thereof, are intended to cover a non-exclusive inclusion, such that a process, method, article, or apparatus that comprises a list of elements includes not only those elements but also other elements not expressly listed, or also includes elements inherent to such process, method, article, or apparatus. Without further limitation, an element defined by the statement “comprises one” does not rule out there are additional identical elements in the process, method, article, or apparatus that includes the element.

While the present disclosure has been illustrated and described with reference to certain preferred embodiments thereof, it should be understood by those of ordinary skill in the art that various changes may be made in form and detail without departing from the scope of the present disclosure.

1. An apparatus, comprising:
a memory for storing instructions;
one or more processors for executing the instructions to cause the apparatus to:
obtain watermark parameters of a target watermark, wherein the watermark parameters include size, thickness, and content of the target watermark;
determine multiple target vertices on the surface of a target 3-dimensional (3D) object, wherein the distance between two vertices in the multiple target vertices is greater than a first distance threshold;
determine candidate boxes on the target 3D object based on the multiple target vertices and the watermark parameters;
determine one or more target boxes meeting a first condition in the candidate boxes based on the watermark parameters of the target watermark, wherein the first condition includes: the roughness corresponding to the one or more target boxes is lower than a roughness threshold, and each of the one or more target boxes indicates a location of the target watermark; and
embed the target watermark to the one or more target boxes on the target 3D object to obtain a watermarked target 3D object.

2. The apparatus of claim 1, wherein determine candidate boxes on the target 3D object based on the multiple target vertices and the watermark parameters comprises:
generating bounding boxes at origin based on the watermark parameters of the target watermark; and
determining candidate boxes by translating and rotating the bounding boxes, wherein normal direction of each of the candidate boxes is the same as normal direction of corresponding target vertex in the multiple target vertices, and centroids of the candidate boxes coincide with the multiple target vertices.

3. The apparatus of claim 2, wherein determining candidate boxes by translating and rotating the bounding boxes comprises:
obtaining a first model, wherein the first model is obtained by training with a training objective as minimizing distance between the surface of a target object and a middle face in a bounding box, wherein the middle face intersects the bounding boxes into two equal parts in height; and
determining candidate boxes by translating and rotating the bounding boxes using the first model.

4. The apparatus of claim 3, wherein determine one or more target boxes meeting a first condition in the candidate boxes based on the watermark parameters of the target watermark comprises:
determining roughness corresponding to each of the candidate boxes; and
taking candidate boxes with the roughness being lower than the roughness threshold as the one or more target boxes.

5. The apparatus of claim 4, wherein determining roughness corresponding to each of the candidate boxes comprises:
determining similarity between normal vectors of vertices within a first target box of the target boxes on the surface of the target object; and
taking an inverse of the similarity as the roughness corresponding to the first target box.

6. The apparatus of claim 5, wherein:
the first condition further comprises: a flow degree of the one or more target boxes is larger than a flow threshold; and
determine one or more target boxes meeting a first condition in the candidate boxes based on the watermark parameters of the target watermark further comprises:
determining a flow degree of each of the candidate boxes; and
taking candidate boxes with the flow degree being larger than the flow threshold as the one or more target boxes.

7. The apparatus of claim 6, wherein determining a flow degree of each of the candidate boxes comprises:
determining first faces inside the first target box, wherein each of the first faces has three vertices inside the first target box;
projecting the first faces along a normal vector of the first target box to obtain first projected areas corresponding to the first faces; and
taking the summation of the first projected areas as the flow degree of the first target box.

8. The apparatus of any one of claim 1, wherein the first condition further comprises at least one of: there being no overlapping boxes between the one or more target boxes, or a distance between the one or more target boxes meets a distance condition.

9. The apparatus of claim 8, wherein the distance condition includes: the distance is larger than a second distance threshold, or the distance is in the top K number of all distances between the candidate boxes.

10. The apparatus of claim 9, wherein the distance between the one or more target boxes is determined based on a distance between centroids of the one or more target boxes.

11. The apparatus of claim 1, wherein embed the target watermark to the one or more target boxes on the target 3D object to obtain a watermarked target 3D object comprises:
generating target watermark meshes at locations of the one or more target boxes based on the watermark parameters; and
obtaining the watermarked target 3D object based on the target watermark meshes and 3D mesh of the target 3D object.

12. The apparatus of claim 11, wherein obtaining the watermarked target 3D object based on the target watermark meshes and 3D mesh of the target 3D object comprises:
determining an intersection face of the 3D mesh and each of the target watermark meshes;
moving each vertex in the intersection face for a first distance along normal vectors of corresponding target watermark mesh to obtain a new target watermark mesh; and
generating the watermarked target 3D object based on the 3D mesh and the new target watermark mesh.

13. The apparatus of claim 12, wherein generating the watermarked target 3D object based on the 3D mesh and the new target watermark mesh comprises:
generating the watermarked target 3D object by taking a Boolean union method of the 3D mesh and the new target watermark mesh.

14. The apparatus of claim 1, wherein the first condition further comprises at least one of:
at least one target box lies within each target part of the target object;
the at least one target box is visible at a first view; or
the at least one target box lies within each face with a span of a first viewing angle on the target object's surface.

15. A method, comprising:
obtaining watermark parameters of a target watermark, wherein the watermark parameters include size, thickness, and content of the target watermark;
determining multiple target vertices on the surface of a target 3-dimensional (3D) object, wherein the distance between two vertices in the multiple target vertices is greater than a first distance threshold;
determining candidate boxes on the target 3D object based on the multiple target vertices and the watermark parameters;
determining one or more target boxes meeting a first condition in the candidate boxes based on the watermark parameters of the target watermark, wherein the first condition includes: the roughness corresponding to the one or more target boxes is lower than a roughness threshold, and each of the one or more target boxes indicates a location of the target watermark; and
embedding the target watermark to the one or more target boxes on the target 3D object to obtain a watermarked target 3D object.

16. The method of claim 15, wherein determining candidate boxes on the target 3D object based on the multiple target vertices and the watermark parameters comprises:
generating bounding boxes at origin based on the watermark parameters of the target watermark; and
determining candidate boxes by translating and rotating the bounding boxes, wherein normal direction of each of the candidate boxes is the same as normal direction of corresponding target vertex in the multiple target vertices, and centroids of the candidate boxes coincide with the multiple target vertices.

17. The method of claim 16, wherein determining candidate boxes by translating and rotating the bounding boxes comprises:
obtaining a first model, wherein the first model is obtained by training with a training objective as minimizing distance between the surface of a target object and a middle face in a bounding box, wherein the middle face intersects the bounding boxes into two equal parts in height; and
determining candidate boxes by translating and rotating the bounding boxes using the first model.

18. The method of claim 17, wherein determining one or more target boxes meeting a first condition in the candidate boxes based on the watermark parameters of the target watermark comprises:
determining roughness corresponding to each of the candidate boxes; and
taking candidate boxes with the roughness being lower than the roughness threshold as the one or more target boxes.

19. The method of claim 18, wherein determining roughness corresponding to each of the candidate boxes comprises:
determining similarity between normal vectors of vertices within a first target box of the target boxes on the surface of the target object; and
taking an inverse of the similarity as the roughness corresponding to the first target box.

20. A non-transitory machine-readable storage medium storing instructions, wherein when the instructions are executed by one or more processors of a machine, cause the machine to:
obtain watermark parameters of a target watermark, wherein the watermark parameters include size, thickness, and content of the target watermark;
determine multiple target vertices on the surface of a target 3-dimensional (3D) object, wherein the distance between two vertices in the multiple target vertices is greater than a first distance threshold;
determine candidate boxes on the target 3D object based on the multiple target vertices and the watermark parameters;
determine one or more target boxes meeting a first condition in the candidate boxes based on the watermark parameters of the target watermark, wherein the first condition includes: the roughness corresponding to the one or more target boxes is lower than a roughness threshold, and each of the one or more target boxes indicates a location of the target watermark; and
embed the target watermark to the one or more target boxes on the target 3D object to obtain a watermarked target 3D object.
